(19) United States
(12) Patent Application Publication
(10) Pub. No.: US 2014/0120375 A1
(43) Pub. Date: May 1, 2014

(54) MAGNETIC RECORDING MEDIUM, METHOD OF MANUFACTURING THE SAME, MAGNET RECORDING/REPRODUCTION APPARATUS, AND STAMPER MANUFACTURING METHOD

(71) Applicant: KABUSHIKI KAISHA TOSHIBA, Tokyo (JP)

(72) Inventors: Kazutaka TAKIZAWA, Kawasaki-shi (JP); Kaori KIMURA, Yokohama-shi (JP); Akira WATANABE, Kawasaki-shi (JP); Akihiko TAKEO, Kokubunji-shi (JP)

(73) Assignee: KABUSHIKI KAISHA TOSHIBA, Tokyo (JP)

(21) Appl. No.: 13/752,876

(22) Filed: Jan. 29, 2013

(30) Foreign Application Priority Data
Oct. 26, 2012 (JP) 2012-236694

(51) Int. Cl. G11B 5/84

(52) U.S. Cl. CPC G11B 5/84
USPC 428/836; 427/130; 427/123

(57) ABSTRACT

According to one embodiment, a magnetic recording medium manufacturing method includes a step of coating the mask layer with a metal fine particle coating solution containing metal fine particles and a first solvent, thereby forming a metal fine particle coating layer having a multilayered structure of the metal fine particles, and a step of dropping, on the coating layer, a second solvent having a second solubility parameter having a difference of 0 to 12.0 from a first solubility parameter of the first solvent, thereby forming a monolayered metal fine particle film by washing away excessive metal fine particles and changing the multilayered structure of the metal fine particles into a monolayer. The projections pattern is made of the monolayered metal fine particle film.

### CROSS-REFERENCE TO RELATED APPLICATIONS

This application is based upon and claims the benefit of priority from Japanese Patent Application No. 2012-236694, filed Oct. 26, 2012, the entire contents of which are incorporated herein by reference.

### FIELD

Embodiments described herein relate generally to a magnetic recording medium, a method of manufacturing the same, a magnetic recording/reproduction apparatus, and a stamper manufacturing method.

### BACKGROUND

Recently, as the amount of information significantly increases, strong demands have arisen for implementing a large-capacity information recording device. As hard disk drive (HDD) techniques, the development of various techniques such as perpendicular magnetic recording has been advanced to increase the recording density. In addition, a patterned medium has been proposed as a medium capable of increasing both the recording density and thermal fluctuation resistance, and the manufacturing techniques of the medium have extensively been developed.

To record one-bit information in one cell of the patterned medium, it is only necessary to magnetically isolate individual recording cells. Therefore, magnetic dot portions and nonmagnetic dot portions are often formed in the same plane by using a micropatterning technique. Alternatively, the magnetism of a recording medium is selectively deactivated by injecting different types of ionized elements. In either case, a general approach is to use micropatterns. More specifically, a projections micropattern is transferred to a magnetic recording layer formed on a substrate by applying a semiconductor manufacturing technique, thereby manufacturing a patterned medium in which a magnetic region and nonmagnetic region are isolated.

To form a projections structure on a mask pattern, it is possible to use a method of obtaining a desired pattern by using a general-purpose resist material used in semiconductor manufacture, a method of performing patterning by physically pressing a preformed projections mold, or a method of obtaining a magnetically isolated medium by forming a projections structure on a mask pattern, and implanting ions irradiated with high energy into a magnetic recording layer, thereby selectively deactivating the pattern magnetism.

To increase the recording density of the patterned medium, it is necessary to decrease the pitch of magnetic dots, and a fine mask is necessary to process the dots. For this purpose, there is a technique of applying metal fine particles to a mask pattern, in addition to ultraviolet exposure or electron beam exposure as the existing technique.

When using metal fine particles as the processing mask, a general method is to coat a substrate with a dispersion in which the metal fine particle material is dispersed in a solvent. Then, a pattern is transferred by using the metal fine particles as a mask after the coating. Consequently, an isolated projections pattern can be obtained. From the viewpoint of signal processing, the size variations of the formed magnetic dots are preferably small over a broad range on the substrate, and the number of defects is preferably small. Accordingly, the metal fine particle layer on the substrate can be a monolayer, i.e., one layer of fine particles can be formed on the substrate.

If simple coating alone is performed when using a coating method such as spin coating or spin casting, however, fine particles on a substrate form a hierarchical structure and produce a structural difference between different positions on the substrate. When transferring a pattern, therefore, this hierarchical structure deteriorates the transfer accuracy, and the in-plane position variation of a projections shape extremely increases. In addition, the HDI (Head Disk Interface) characteristic worsens because the amount of residue on the substrate increases.

Examples of the conventional technique of forming a monolayer of metal fine particles over a broad range of a substrate are a method of forming a monolayer by pressing multiple metal fine particle layers with a pressing plate, and a method of optimizing the coating conditions. However, it is difficult to form a monolayer from a hierarchical structure on a substrate because, e.g., the throughput decreases or the processing margin is narrow.

### BRIEF DESCRIPTION OF THE DRAWINGS

FIGS. 1A, 1B, 1C, 1D, 1E, 1F, 1G, 1H, and 11 are views showing the manufacturing steps of a magnetic recording medium according to the first embodiment;

FIGS. 2A, 2B, 2C, 2D, 2E, 2F, 2G, 2H, 2I, and 2J are views showing the manufacturing steps of a magnetic recording medium according to the second embodiment;

FIGS. 3A, 3B, 3C, 3D, 3E, 3F, 3G, 3H, 3I, and 3J are views showing the manufacturing steps of a magnetic recording medium according to the third embodiment;

FIGS. 4A, 4B, 4C, 4D, 4E, 4F, 4G, 4H, 4I, and 4J are views showing the manufacturing steps of a magnetic recording medium according to the fourth embodiment;

FIGS. 5A, 5B, 5C, 5D, 5E, 5F, and 5G are views for explaining an example of a stamper manufacturing method;

FIGS. 6A, 6B, 6C, 6D, 6E, 6F, 6G, 6H, and 6I are views for explaining another example of the stamper manufacturing method;

FIGS. 7A, 7B, 7C, 7D, 7E, 7F, 7G, and 7H are views for explaining another example of the method of manufacturing the magnetic recording medium according to the first embodiment;

FIG. 8 is a view showing examples of recording bit patterns in the circumferential direction of a magnetic recording medium;

FIG. 9 is a view showing another example of the recording bit pattern of the magnetic recording medium;

FIG. 10 is a partially exploded perspective view showing an example of a magnetic recording/reproduction apparatus to which the magnetic recording medium according to an embodiment is applicable;

FIGS. 11A and 11B are views for explaining a step of forming a metal fine particle monolayer according to an embodiment; and

FIG. 12 is a photograph showing a sectional image of a metal fine particle layer according to an embodiment.

### DETAILED DESCRIPTION

In general, according to one embodiment, a magnetic recording medium manufacturing method includes steps of forming a magnetic recording layer on a substrate, forming a mask layer on the magnetic recording layer, forming a projections pattern on the mask layer, transferring the projections pattern to the mask layer, transferring the projections pattern to the magnetic recording layer, and removing the mask layer from the magnetic recording layer.

The step of forming the projections pattern on the mask layer includes a step of coating the mask layer with a metal fine particle coating solution containing metal fine particles and a first solvent, thereby forming a metal fine particle coating layer having a multilayered structure of the metal fine particles, and a step of dropping, on the metal fine particle coating layer, a second solvent having a second solubility parameter having a difference of 0 to 12.0 from a first solubility parameter of the first solvent, thereby forming a monolayered metal fine particle film by washing away excessive metal fine particles and changing the multilayered structure of the metal fine particles into a monolayer. The projections pattern is formed by the monolayered metal fine particle film. The optimum range of the difference between the solubility parameter values changes in accordance with whether the first and second solvents are polar solvents or nonpolar solvents. More specifically, the solubility parameter difference can be 12.0 or less when the first and second solvents are polar solvents, and can be 3.0 or less when they are nonpolar solvents.

The magnetic recording medium manufacturing method according to the embodiment can be classified into the first to fourth embodiments.

The first embodiment includes a step of removing the metal fine particle film after the step of transferring the projections pattern to the mask layer, and the step of transferring the projections pattern to the magnetic recording layer.

The second embodiment includes a step of removing the metal fine particle portion between the step of transferring the projections pattern to the mask layer, and the step of transferring the projections pattern to the magnetic recording layer.

The third embodiment includes a step of forming a transfer layer on the mask layer before the step of forming the projections pattern on the mask layer. In the step of forming the projections pattern on the mask layer, a metal fine particle coating layer having a multilayered structure of the metal fine particles is formed by coating the transfer layer with a metal fine particle coating solution, instead of coating the mask layer with the metal fine particle coating solution. The third embodiment further includes a step of transferring the projections pattern to the transfer layer before the step of transferring the projections pattern to the mask layer.

The fourth embodiment further includes a step of forming a release layer on the magnetic recording layer before the step of forming the mask layer on the magnetic recording layer, and a step of transferring the projections pattern to the release layer before the step of transferring the projections pattern to the magnetic recording layer. After the step of transferring the projections pattern to the magnetic recording layer, the mask layer is removed from the magnetic recording layer by removing the release layer.

The monolayered metal fine particle film herein mentioned means a state in which a plurality of metal fine particles are arranged into the shape of a monolayer.

Also, the second solvent used in the embodiments is used to change the multilayered structure of the metal fine particles into a monolayer by washing away excessive metal fine particles. In this specification, the second solvent will be referred to as a rinsing solution as needed.

The metal fine particles used in the embodiments can be selected from fine particles of metals such as carbon, aluminum, silicon, titanium, iron, cobalt, nickel, copper, zinc, zirconium, molybdenum, ruthenium, palladium, silver, tantalum, tungsten, platinum, gold, and cerium, and fine particles of alloys and compounds of these metals.

In the embodiments, the metal fine particles are dispersed in the first solvent and used as a metal fine particle coating solution.

Also, the difference between the first solubility parameter of the first solvent and the second solubility parameter of the second solvent is 0 to 12.0. This means that the second solvent as a rinsing solution for changing the multilayered structure into a monolayer is selected from a material compatible with the first solvent. The difference between the first and second solubility parameters may also be 0, and this means that the same material can be used as the first and second solvents.

Note that the difference between the first and second solubility parameters can be 12.0 or less when using polar solvents, and can be 3.0 or less when using nonpolar solvents. Note also that different solvents can be used as the first and second solvents.

In the embodiments, it is possible to form the multilayered structure of the metal fine particles by coating of the metal fine particle coating solution containing the metal fine particles and first solvent, fluidize the multilayered structure by coating of the second solvent as a rinsing solution, and form a monolayer by washing away excessive metal fine particles.

The coating of the first and second solvents is performed by various methods such as spin coating, dip coating, spin casting, a Langmuir-Blodgett method, and an ink-jet method.

The projections pattern made of the metal fine particles is transferred to the mask layer by etching. In the third embodiment, one transfer layer can be formed between the metal fine particles and mask layer in order to increase the pattern transfer accuracy.

After the projections pattern is transferred to the magnetic recording layer, the mask layer is removed from the magnetic recording layer by etching. Alternatively, it is also possible to preform a release layer on the magnetic recording layer, and remove the mask layer from the magnetic recording layer by removing the release layer. The release layer is removed by dry etching or wet etching.

The magnetic recording medium manufacturing method according to any of the above-mentioned embodiments can decrease the dependence of the projections pattern transfer accuracy on a position by the monolayered metal fine particle film formed over a broad range on the substrate, and can manufacture a magnetic recording medium having high in-plane uniformity. In addition, the glide characteristic improves when scanning a head over the medium, because the hierarchical structure of the metal fine particles is planarized. Furthermore, it is possible to easily manufacture micropatterns suitable for high-density recording, and simplify the manufacturing process.

Note that the first to fourth embodiments described above can be combined with each other when practiced.

The embodiments will be explained below with reference to the accompanying drawings.

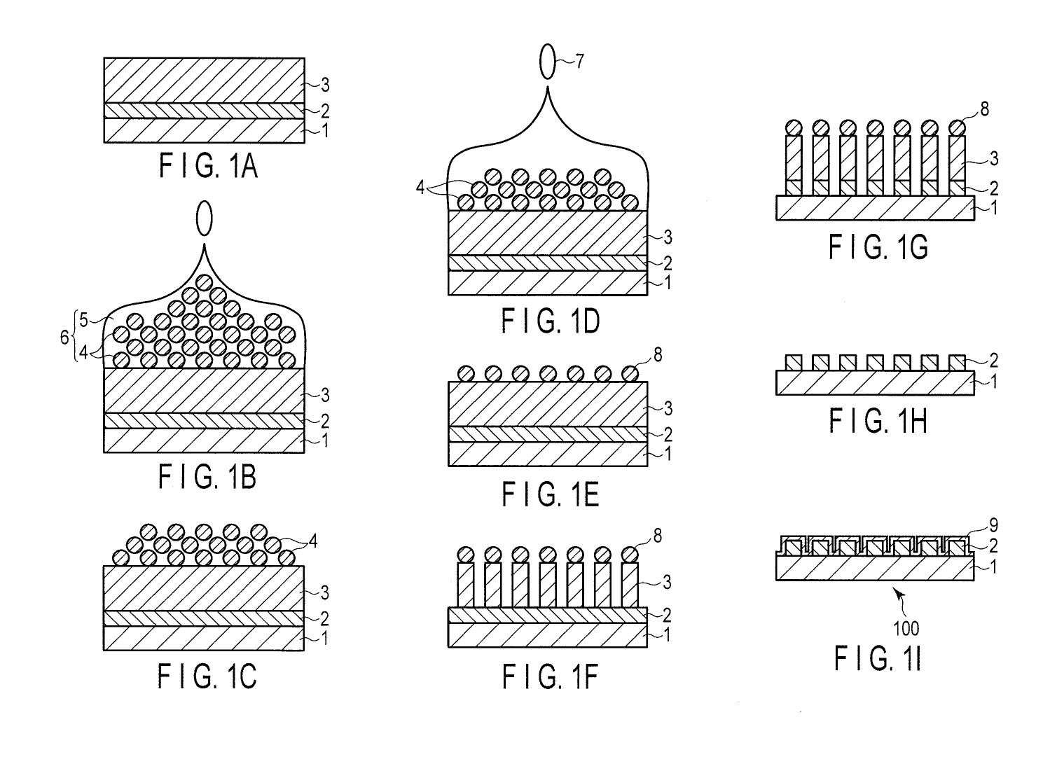

FIGS. 1A, 1B, 1C, 1D, 1E, 1F, 1G, 1H, and 1I are views showing the manufacturing steps of the magnetic recording medium according to the first embodiment.

First, a magnetic recording medium having a magnetic recording layer formed on a substrate is prepared.

As shown in FIG. 1A, a mask layer 3 is formed on a magnetic recording layer 2 formed on a substrate 1.

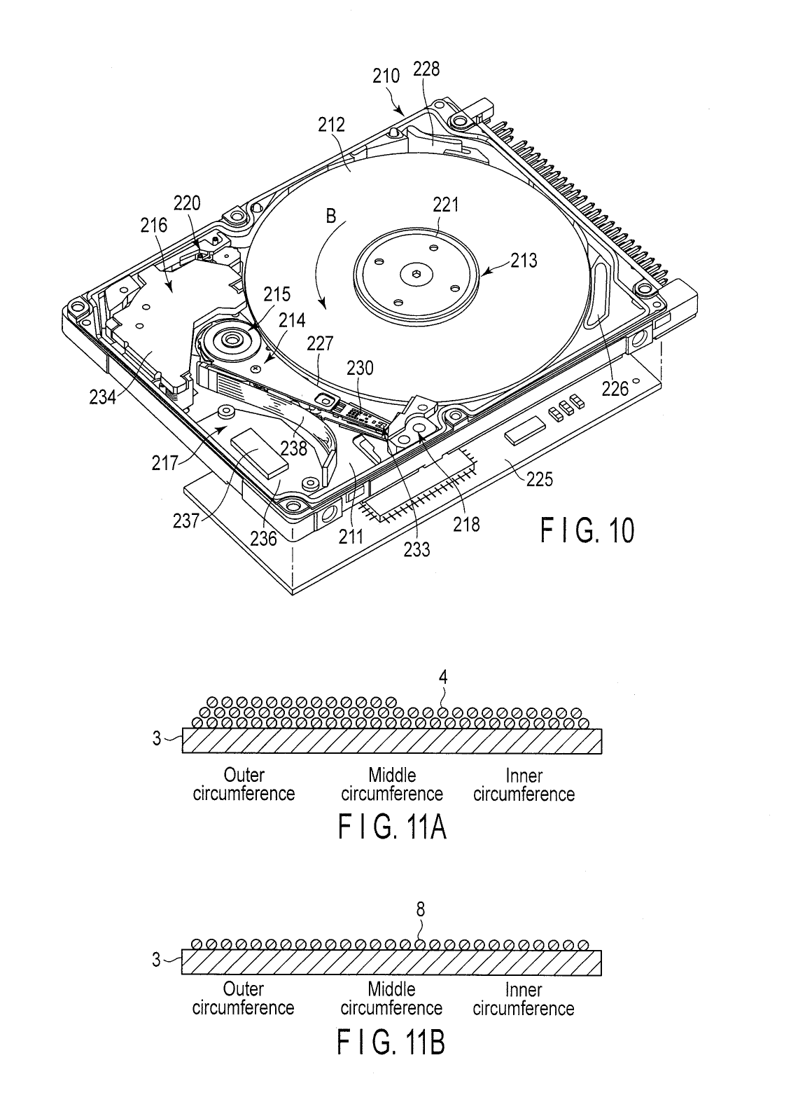

Then, as shown in FIG. 1B, a metal fine particle coating solution containing metal fine particles and a first solvent 5 is dropped on the mask layer 3, thereby coating the mask layer 3 with the solution. In addition, as shown in FIG. 10, a metal fine particle coating layer 6 including a multilayered structure containing metal fine particles 4 and the first solvent 5 is formed on the mask layer 3.

Subsequently, as shown in FIG. 1D, a second solvent 7 is dropped on the multilayered structure containing the metal fine particles 4 to coat the multilayered structure with the solvent, thereby fluidizing the metal fine particles and washing away excessive metal fine particles. Consequently, as shown in FIG. 1E, a monolayered metal fine particle film 8 in which a plurality of metal fine particles are regularly arranged is obtained.

As shown in FIG. 1F, a projections pattern formed by the monolayered metal fine particle film 8 is transferred to the mask layer 3.

Then, as shown in FIG. 1G, the projections pattern is transferred to the magnetic recording layer 2 via the monolayered metal fine particle film 8 and patterned mask layer 3.

Subsequently, as shown in FIG. 1H, the mask layer 3 and monolayered metal fine particle film 8 on the magnetic recording layer 2 are removed, thereby obtaining the substrate 1 and the patterned magnetic recording layer 2 formed on the substrate 1.

Finally, a magnetic recording medium 100 can be obtained by forming a protective film 9 on the patterned magnetic recording layer 2.

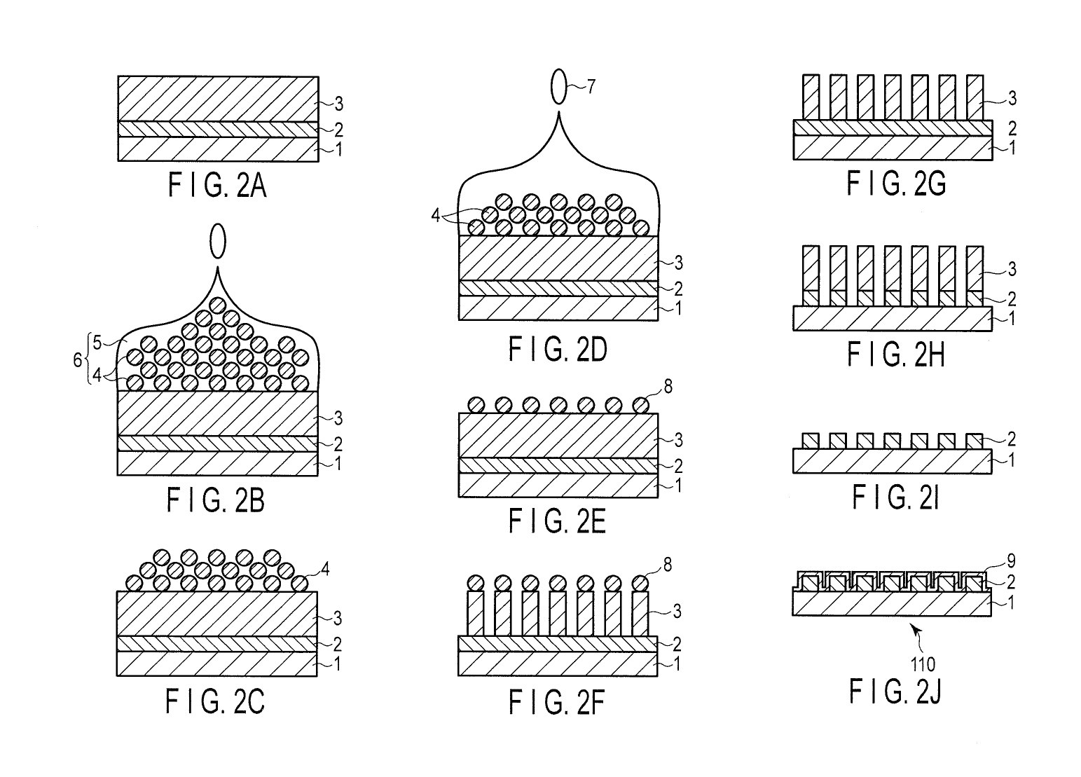

FIGS. 2A, 2B, 2C, 2D, 2E, 2F, 2G, 2H, 2I, and 2J are views showing the manufacturing steps of the magnetic recording medium according to the second embodiment.

In the manufacturing steps of the magnetic recording medium according to the second embodiment, a magnetic recording medium 110 can be obtained following the same procedures as shown in FIGS. 1A, 1B, 1C, 1D, 1E, 1F, 1G, 1H, and 1I, except that after a monolayered metal fine particle film 8 on a mask layer 3 is removed as shown in FIG. 2G, a projections pattern is transferred to a magnetic recording layer 2 via the mask layer 3 as shown in FIG. 2H, instead of transferring the projections pattern to the magnetic recording layer 2 via the monolayered metal fine particle film 8 and mask layer 3 as shown in FIG. 1G.

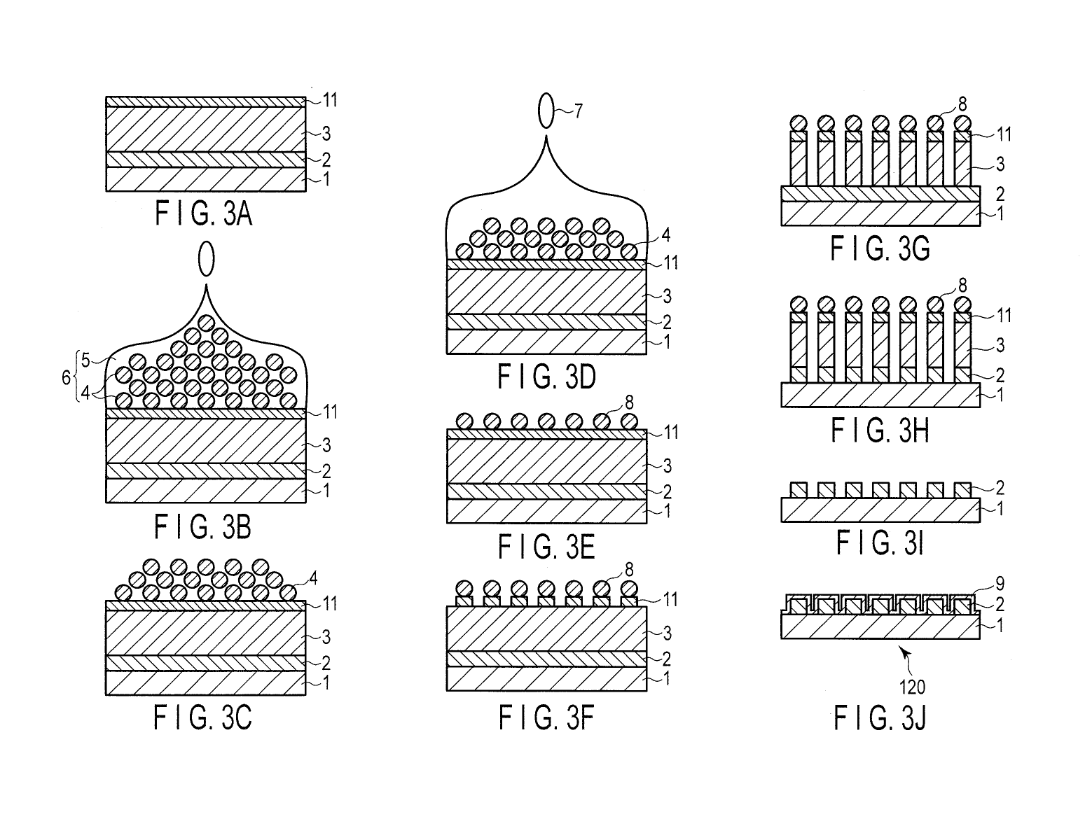

FIGS. 3A, 3B, 3C, 3D, 3E, 3F, 3G, 3H, 3I, and 3J are views showing the manufacturing steps of the magnetic recording medium according to the third embodiment.

In the manufacturing steps of the magnetic recording medium according to the third embodiment, a magnetic recording medium 120 can be obtained following the same procedures as shown in FIGS. 1A, 1B, 1C, 1D, 1E, 1F, 1G, 1H, and 1I, except that a transfer layer 11 is additionally formed on a mask layer 3 formed on a magnetic recording layer 2 as shown in FIG. 3A, a projections pattern is transferred to the transfer layer 11 by using a monolayered metal fine particle film 8 as shown in FIG. 3F, and the projections pattern of the transfer layer 11 is transferred to the mask layer 3 as shown in FIG. 3G.

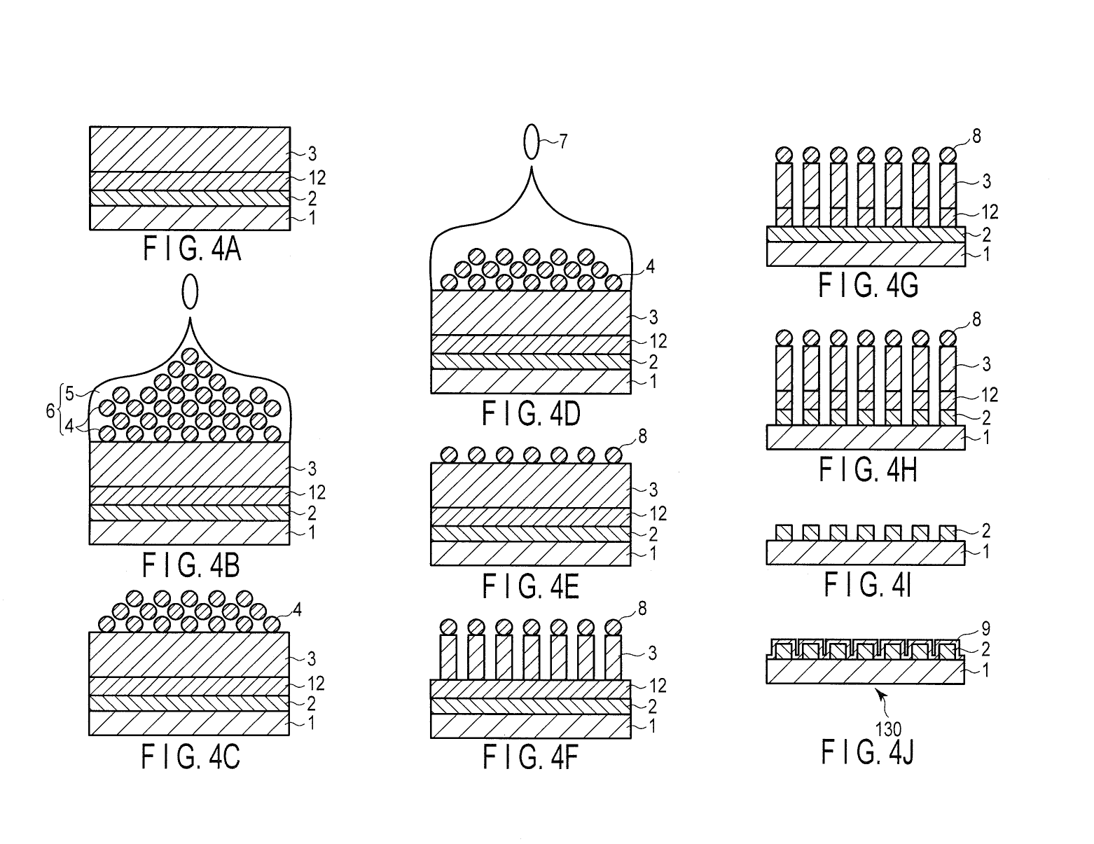

FIGS. 4A, 4B, 4C, 4D, 4E, 4F, 4G, 4H, 4I, and 4J are views showing the manufacturing steps of the magnetic recording medium according to the fourth embodiment.

In the manufacturing steps of the magnetic recording medium according to the fourth embodiment, a magnetic recording medium 130 can be obtained following the same procedures as shown in FIGS. 1A, 1B, 1C, 1D, 1E, 1F, 1G, 1H, and 1I, except that a release layer is additionally formed between a magnetic recording layer 2 and mask layer 3 formed on a substrate 1 as shown in FIG. 4A, a projections pattern is transferred to the release layer 12 before being transferred to the magnetic recording layer 2 as shown in FIG. 4G, and the mask layer 3 and a metal fine particle film 8 are removed from the magnetic recording layer 2 by removing the release layer 12 instead of the mask layer 3 as shown in FIG. 41.

### Magnetic Recording Layer Formation Step

First, a magnetic recording medium is obtained by forming a magnetic recording layer on a substrate.

Although the shape of the substrate is not limited at all, the substrate is normally circular and made of a hard material. Examples are a glass substrate, metal-containing substrate, carbon substrate, and ceramics substrate. To improve the pattern in-plane uniformity, the roughness of the substrate surface can be decreased. It is also possible to form a protective film such as an oxide film on the substrate surface as needed.

As the glass substrate, it is possible to use amorphous glass such as soda lime glass or aluminosilicate glass, or crystallized glass such as lithium-based glass. Furthermore, a sintered substrate mainly containing alumina, aluminum nitride, or silicon nitride can be used as the ceramics substrate.

A magnetic recording layer including a perpendicular magnetic recording layer mainly containing cobalt is formed on the substrate.

A soft under layer (SUL) having a high magnetic permeability can be formed between the substrate and perpendicular magnetic recording layer. The soft under layer returns a recording magnetic field from a magnetic head for magnetizing the perpendicular magnetic recording layer, i.e., performs a part of the magnetic head function. The soft under layer can apply a sufficient steep perpendicular magnetic field to the magnetic field recording layer, thereby increasing the recording/reproduction efficiency.

A material containing Fe, Ni, or Co can be used as the soft under layer. Among these materials, it is possible to use an amorphous material having none of magnetocrystalline anisotropy, a crystal defect, and a grain boundary, and showing a high soft magnetism. The soft amorphous material can reduce the noise of the recording medium. An example of the soft amorphous material is a Co alloy mainly containing Co and also containing at least one of Zr, Nb, Hf, Ti, and Ta. For example, it is possible to select CoZr, CoZrNb, and CoZrTa.

In addition, a base layer for improving the adhesion of the soft under layer can be formed between the soft under layer and substrate. As the base layer material, it is possible to use, e.g., Ni, Ti, Ta, W, Cr, Pt, and alloys, oxides, and nitrides of these elements. For example, it is possible to use NiTa and NiCr. Note that the base layer can include a plurality of layers.

Furthermore, an interlayer made of a nonmagnetic metal material can be formed between the soft under layer and perpendicular magnetic recording layer. The interlayer has two functions: one is to interrupt the exchange coupling interaction between the soft under layer and perpendicular magnetic recording layer; and the other is to control the crystallinity of the perpendicular magnetic recording layer. The interlayer material can be selected from Ru, Pt, Pd, W, Ti, Ta, Cr, Si, and alloys, oxides, and nitrides of these elements.

The perpendicular magnetic recording layer mainly contains Co, also contains at least Pt, and can further contain a metal oxide. In addition to Co and Pt, the layer can also contain one or more elements selected from B, Ta, Mo, Cu, Nd, W, Nb, Sm, Tb, and Ru. When these elements are contained, it is possible to promote downsizing of magnetic grains, and improve the crystallinity and alignment, thereby obtaining recording/reproduction characteristics and thermal fluctuation characteristics more suitable for a high recording density. Practical examples of the material usable as the perpendicular magnetic recording layer are alloys such as a CoPt-based alloy, a CoCr-based alloy, a CoCrPt-based alloy, CoPtO, CoPtCrO, CoPtSi, CoPtCrSi, and CoCrSiO₂.

The thickness of the perpendicular magnetic recording layer can be set to 1.0 nm or more in order to measure a reproduced output signal with high accuracy, and can be set to 40 nm or less in order to suppress the distortion of the signal intensity. If the thickness is smaller than 1.0 nm, the reproduced output is extremely low, and the noise component becomes dominant. On the other hand, if the thickness is larger than 40 nm, the reproduced output becomes excessive, and the signal waveform is distorted.

A protective layer can be formed on the perpendicular magnetic recording layer. The protective layer has the effect of preventing corrosion and deterioration of the perpendicular magnetic recording layer, and preventing damage to the medium surface when a magnetic head comes in contact with the recording medium. Examples of the protective layer material are materials containing C, Pd, SiO₂, and ZrO₂. Carbon can be classified into sp²-bonded carbon (graphite) and sp³-bonded carbon (diamond). Sp³-bonded carbon is superior in durability and corrosion resistance, and sp²-bonded carbon is superior in flatness. Carbon is normally deposited by sputtering using a graphite target, and amorphous carbon containing both sp²-bonded carbon and sp³-bonded carbon is deposited. Carbon in which the ratio of sp³-bonded carbon is high is called diamond-like carbon (DLC). DLC is superior in durability, corrosion resistance, and flatness, and usable as the protective layer of the magnetic recording layer.

Furthermore, a lubricating layer can be formed on the protective layer. Examples of a lubricant used in the lubricating layer are perfluoropolyether, alcohol fluoride, and fluorinated carboxylic acid. By the process described above, a perpendicular magnetic recording medium is formed on the substrate.

### Mask Layer Formation Step

A mask layer for transferring a projections pattern is formed on the magnetic recording layer.

When the protective layer is formed on the magnetic recording layer, the mask layer can be formed on the protective layer.

Since the mask layer functions as a main mask when processing the magnetic recording layer, a material capable of maintaining the etching selectivity to the magnetic recording layer and a metal fine particle material (to be described later) can be used. A practical material can be selected from the group consisting of, e.g., Al, C, Si, Ti, V, Cr, Mn, Co, Ni, Cu, Fe, Zn, Ga, Zr, Nb, Mo, Ru, Pd, Ag, Au, Hf, Ta, W, and Pt. It is also possible to apply materials made of compounds or alloys of these elements to the mask layer. The compound is selected from, e.g., an oxide, nitride, boride, and carbide, and the alloy contains two or more materials selected from the above-mentioned group. In this case, it is possible to select a mask layer material capable of securing the etching selectivity to the material and projections pattern dimensions of a metal fine particle film to be formed on the mask layer, and properly determine the film thickness of the mask layer.

These mask layers can be formed by physical vapor deposition (PVD) such as vacuum deposition, electron beam deposition, molecular beam deposition, ion beam deposition, ion plating, or sputtering, or chemical vapor deposition (CVD) using heat, light, or plasma.

When using physical or chemical vapor deposition, the thickness of the mask layer can be adjusted by properly changing parameters such as the process gas pressure, gas flow rate, substrate temperature, input power, ultimate vacuum degree, chamber ambient, and deposition time. The arrangement accuracy of a metal fine particle layer to be formed on the mask layer and the transfer accuracy of the projections pattern strongly depend on the surface roughness of the mask layer. Therefore, the surface roughness of the mask layer can be reduced by variously adjusting the above-mentioned deposition conditions. To precisely pattern a narrow-pitch pattern, the period of the surface roughness can be made smaller than the desired pattern pitch. Also, the value of the average surface roughness can be 0.6 nm or less. If this value is larger than 0.6 nm, the arrangement accuracy of metal fine particles (to be described later) tends to decrease, and this often decreases the signal S/N of the magnetic recording medium.

The surface roughness can be reduced by variously changing the above-mentioned deposition conditions, or by changing the mask layer material from a crystalline material to an amorphous material.

The mask layer thickness can be determined by taking account of the etching selectivity to the release layer and magnetic recording layer, and the projections pattern dimensions. When depositing the mask layer, the mask layer thickness can be adjusted by properly changing parameters such as the process gas pressure, gas flow rate, substrate temperature, input power, ultimate vacuum degree, chamber ambient, and deposition time. A sputtering gas for use in deposition can mainly contain a rare gas such as Ar, and a desired alloy can be deposited by mixing a reactive gas such as O₂ or N₂ in accordance with a mask material to be deposited.

Also, the mask layer thickness can be set to 1 (inclusive) to 50 (inclusive) nm in order to precisely transfer a micropattern. If the thickness is smaller than 1 nm, no uniform mask layer can be deposited. If the thickness exceeds 50 nm, the projections pattern transfer accuracy in the depth direction tends to decrease.

As will be described later, a magnetic recording layer having a projections structure can be obtained by forming a projections pattern on the magnetic recording layer via the mask layer, and removing the mask layer. When removing the mask layer, a method such as dry etching or wet etching is applied. However, it is also possible to preform a release layer between the mask layer and magnetic recording layer, and remove the mask layer from the magnetic recording layer by removing this release layer. When the protective layer is formed on the magnetic recording layer, the release layer can be formed on the protective layer.

The release layer is removed by dry etching or wet etching, and finally achieves the function of removing the mask material from the magnetic recording layer.

The release layer can be selected from various inorganic materials and polymer materials, and an etching solution capable of dissolving the material can properly be selected.

Examples of the inorganic material usable as the release layer are metals and compounds such as C, Mo, W, Zn, Co, Ge, Al, Cu, Au, Ag, Ni, Si, SiO₂, and Cr, and alloys containing two or more types of metals. These inorganic materials can be removed by dry etching using an etching gas such as O₂, CF₄, Cl₂, H₂, N₂, or Ar.

It is also possible to apply, to each material, an acid such as hydrochloric acid, phosphoric acid, nitric acid, boric acid, acetic acid, hydrofluoric acid, ammonium fluoride, perchloric acid, hydrobromic acid, carboxylic acid, sulfonic acid, or a hydrogen peroxide solution, or an alkali solution such as an aqueous sodium hydroxide solution, an aqueous potassium hydroxide solution, an aqueous calcium hydroxide solution, an aqueous barium hydroxide solution, an aqueous magnesium hydroxide solution, an aqueous ammonium hydroxide solution, tetramethylammoniumhydroxide, tetrapropylammoniumhydroxide, or phenyltrimethylammoniumhydroxide.

It is also possible to appropriately add a buffer solution for adjusting the pH of a solution.

A polymer material can also be applied to the release layer. Examples are general-purpose resist materials such as a novolak resin, polystyrene, polymethylmethacrylate, methylstyrene, polyethyleneterephthalate, polyhydroxystyrene, polyvinylpyrrolidone, and polymethylcellulose. These resist materials can be removed by using an organic solvent or water. Note that it is also possible to use a composite material containing a polymer material and metal in order to increase the etching resistance.

When dissolving the release layer by wet etching using any of the above-mentioned acids, alkalis, and organic solvents, the dissolution rates of the magnetic recording layer and substrate can be made much lower than that of the release layer.

It is possible to form one mask layer or two or more mask layers. The mask layer on the magnetic recording layer and release layer as described above can have a multilayered structure including first and second mask layers. By forming the first and second mask layers by using different materials, for example, it is possible to increase the etching selectivity and transfer accuracy. For the sake of convenience, the second mask layer will be called a transfer layer with respect to the first mask layer, and the description will be given like “a magnetic recording layer/mask layer/transfer layer from the substrate side”.

This transfer layer can properly be selected from various materials by taking account of the etching selectivity to the metal fine particle material and mask layer material. When determining a combination of the mask materials, it is possible to select metal materials corresponding to an etching solution or etching gas. When combining materials by assuming dry etching, examples are C/Si, Si/Al, Si/Ni, Si/Cu, Si/Mo, Si/MoSi₂, Si/Ta, Si/Cr, Si/W, Si/Ti, Si/Ru, and Si/Hf in the order of the mask layer/transfer layer from the substrate side, and Si can be replaced with SiO₂, Si₃N₄, SiC, or the like. It is also possible to select multilayered structures such as Al/Ni, Al/Ti, Al/TiO₂, Al/TiN, Cr/Al₂O₃, Cr/Ni, Cr/MoSi₂, Cr/W, GaN/Ni, GaN/NiTa, GaN/NiV, Ta/Ni, Ta/Cu, Ta/Al, and Ta/Cr. Note that the stacking order of these various mask materials can be changed in accordance with an etching gas to be used in mask processing.

The combination of the mask materials and the stacking order are not limited to those enumerated above, and can properly be selected from the viewpoints of the pattern dimensions and etching selectivity. Since patterning by wet etching is also possible as well as dry etching, each mask material can be selected by taking this into account.

When patterning the mask layer by wet etching, side etch in the widthwise direction of the projections pattern is suppressed. This can be implemented by setting various parameters such as the composition of the mask material, the concentration of the etching solution, and the etching time.

### Metal Microparticle Layer Formation Step

Subsequently, a metal fine particle layer as a projections pattern is formed on the mask layer. When using metal fine particles as a projections mask, the metal fine particles can be arranged into a monolayer over a broad range on the substrate, thereby decreasing the positional variation of the signal intensity in the magnetic recording medium. In addition, a good glide characteristic is obtained because abnormal projections reduce after pattern transfer.

The metal fine particle layer formation step includes the following two steps: (1) a step of arranging metal fine particles having a multilayered structure on the substrate; and (2) a step of fluidizing the metal fine particles having the multilayered structure by dropping a solvent, thereby forming a monolayer of the metal fine particles.

First, a metal fine particle coating solution for coating the mask layer is prepared. This coating solution is prepared by monodispersing at least one type of metal fine particles in a solvent. “Monodispersion” herein mentioned means that metal fine particles neither aggregate nor fuse but independently exist in a solvent.

In order for metal fine particles to be stably dispersed in a solvent, the surfaces of the metal fine particles can be covered with a protective material. The definition of this protective material is that the material contains a surfactant and covers the surfaces of the metal fine particles. As the protective material, it is possible to use a material having high affinity to the metal fine particle material.

Examples of the protective material are protective groups such as a thiol group, amino group, ketone group, carboxyl group, ether group, and hydroxy group. More specifically, it is possible to use alkanethiol, dodecanethiol, polyvinylpyrrolidone, and oleylamine.

As the metal fine particle material, it is possible to use at least one element selected from the group consisting of C, Pt, Ni, Pd, Co, Al, Ti, Ce, Si, Fe, Au, Ag, Cu, Ta, Zr, Zn, Mo, W, and Ru, or an alloy, mixture, or oxide containing two or more elements elected from the above group.

Also, as the size of metal fine particles, the distance between the centers of adjacent metal fine particles, i.e., the pitch is 20 nm or less. This is so because if metal fine particles having a pitch larger than 20 nm are used, the volume of the protective material existing per unit surface area of the metal fine particles increases, and this increases the interaction between the fine particles and makes a monolayer (to be described later) difficult to form.

The solvent for dispersing the metal fine particles can be selected from various organic solvents. Practical examples are toluene, xylene, hexane, heptane, octane, ethyleneglycol monoethylether, ethyleneglycol monomethylether, ethyleneglycol monomethyletheracetate, propyleneglycol monomethyletheracetate, ethyleneglycol trimethylether, ethyl lactate, ethyl pyruvate, tetradecane, cyclohexanone, dimethylformamide, dimethylacetamide, tetrahydrofuran, anisole, diethyleneglycol triethylether, ethanol, methanol, isopropanol, and water.

A metal fine particle coating solution is obtained by mixing the metal fine particles and solvent as described above. Note that if the fine particles aggregate, it is possible to redisperse the metal fine particles after mixing by using a method such as ultrasonic dispersion.

A dispersant for accelerating the monodispersion of the metal fine particles may also be added to the metal fine particle coating solution. This dispersant can properly be selected with respect to the combination of the protective material and solvent, and can be selected from, e.g., sodium polycarboxylate, ammonium polycarboxylate, amine polycarboxylate, polyalkylamine, and polyamine.

Furthermore, various polymer materials can be added as binders to the metal fine particle coating solution. This makes it possible to improve the coating properties to the mask layer, and strengthen the fixation of a pattern to the base.

A polymer material to be used as the binder need only be dissolved in a first solvent, and it is possible to use, e.g., polystyrene or polymethylmethacrylate.

The metal fine particle coating solution prepared by monodispersing the metal fine particles in the solvent is dropped on the mask layer, thereby coating the mask layer with the solution. This coating of the coating solution can be performed by various methods such as spin coating, spray coating, spin casting, dip coating, and an ink-jet method. The amount of coating solution to be dropped on the mask layer need only be set to an amount with which a desired coating area is sufficiently covered. Also, when forming multiple metal fine particle layers, it is only necessary to variously adjust the solution concentration, solution viscosity, and coating conditions. When using spin coating, for example, the rotating speed can be set to 10,000 rpm or less in order to form a multilayered structure in a large area. If the rotating speed exceeds 10,000 rpm, defective regions of the metal fine particles extend, and this often makes a monolayer difficult to form.

By performing a pre-process on the surface of the mask layer, it is possible to increase the affinity to the metal fine particle coating solution, thereby improving the coating properties of the metal fine particle coating solution, i.e., the in-plane uniformity. Examples are a method of heating the substrate or applying a silane coupling agent, and a method of forming a polymer material having a high affinity to the solvent on the mask layer.

Subsequently, the formed metal fine particle multilayered structure is planarized to form a monolayer on the mask layer. This process is performed by a rinsing step of dropping a rinsing solution containing the second solvent to fluidize the multilayered portion of the metal fine particles, thereby removing the multilayered portion from the monolayer portion fixed on the mask layer. As described previously, the rinsing step herein mentioned means the formation of a metal fine particle monolayer by the second solvent.

When selecting the rinsing solution, a solubility parameter (SP value) is taken into consideration as an index representing the solubility between solvents. That is, letting ΔE be the aggregation energy and V be the molar volume, the solubility parameter is represented by SP=(ΔE/V)^{1/2}. The SP value is unique to each solvent, and solvents having a small SP value difference easily dissolve each other, i.e., have compatibility with each other.

In this embodiment, appropriate materials are selected so that the metal fine particle coating solution and rinsing solution, i.e., the first and second solvents have compatibility with each other. Table 1 shows a list of examples of the solvents for use in the metal fine particle coating solution and rinsing solution, and the SP values of the solvents. The first solubility parameter and the second solubility parameter may be 7 to 24. When preparing a metal fine particle coating solution, it is possible to properly set the SP values of these various solvents and protective materials. Also, the second solvent is desirably compatible with the first solvent. More specifically, the SP value difference between the two solvents can be set to 12.0 or less. This is so because if the two solvents are sparingly soluble in each other, they do not dissolve in the solvent contained in the multilayered structure, and cannot fluidize the metal fine particle layer.

The second solvent can be dropped and used as a rinsing solution by various methods such as spin coating in the same manner as that for the first solvent. In the multilayered metal fine particles, the fixation of the monolayered metal fine particle film to the mask layer surface is relatively strong, whereas the fixation of the multilayered portion is relatively weak. Performing rinsing by using the second solvent compatible with the first solvent remaining in the multilayered portion makes it possible to fluidize the multilayered portion, remove excessive metal fine particles, and leave only the monolayered portion behind on the mask layer surface.

TABLE 1

| | Solubility parameter |
|---|---|
| Solvent species | (SP value) (cal/cm³)^{1/2} |
| Pentane | 7 |
| Hexane | 7.3 |
| Octane | 7.6 |
| Toluene | 8.9 |
| Xylene | 8.8 |
| Cyclohexanone | 8.2 |
| Methyl ethyl ketone | 9.3 |
| Tetrahydrofuran | 9.1 |
| Tetradecane | 7.7 |
| PGMEA | 7.3 |
| Ethyl acetate | 9.1 |
| Butyl acetate | 8.5 |
| Isobutyl acetate | 8.3 |
| Isopropyl acetate | 8.4 |
| Diethyl ether | 7.4 |
| Acetone | 9.8 |
| Pyridine | 10.7 |
| Acetic acid | 10.1 |
| Cyclohexanol | 11.4 |
| Dimethylformamide | 12 |
| Ethanol | 12.7 |
| Methanol | 14.5 |
| Isopropyl alcohol | 11.5 |
| Butanol | 11.4 |
| Ethyleneglycol | 14.6 |
| Formamide | 19.2 |
| Water | 23.4 |

### Mask Layer Patterning Step

Then, the metal fine particle monolayer is transferred as a projections pattern to the mask layer.

When processing the mask layer, it is possible to implement various layer arrangements and processing methods by combining mask layer materials and etching gases.

Dry etching is applicable when performing micropatterning such that etching in the thickness direction of the projections pattern is significant with respect to etching in the widthwise direction. Plasma usable in dry etching can be generated by various methods such as capacitive coupling, inductive coupling, electron cyclotron resonance, and multi-frequency superposition coupling. Also, to adjust the pattern dimensions of the projections pattern, it is possible to set parameters such as the process gas pressure, gas flow rate, plasma input power, bias power, substrate temperature, chamber ambient, and ultimate vacuum degree.

When stacking mask materials in order to increase the etching selectivity, an etching gas can properly be selected. Examples of the etching gas are fluorine-based gases such as CF₄, C₂F₆, C₃F₆, C₃F₈, C₅F₈, C₄F₈, ClF₃, CCl₃F₅, C₂ClF₅, CCBrF₃, CHF₃, NF₃, and CH₂F₂, and chlorine-based gases such as Cl₂, BCl₃, CCl₄, and SiCl₄. Other various gases such as H₂, N₂, O₂, Br₂, HBr, NH₃, CO, C₂H₄, He, Ne, Ar, Kr, and Xe can also be applied. It is also possible to use a gas mixture obtained by mixing two or more types of these gases in order to adjust the etching rate or etching selectivity. Note that patterning can also be performed by wet etching. In this case, it is favorable to select an etching solution capable of securing the etching selectivity and suppressing etching in the widthwise direction. Similarly, physical etching such as ion milling can be performed.

As in the second embodiment, after the metal fine particle pattern is transferred to the mask layer, the metal fine particles can be removed from the mask layer. When the metal fine particles are removed, it is possible to reduce the blockade of pattern grooves by by-products of etching, and reduce the aggregation of the fine particles.

The above-mentioned dry etching is applicable to the removal of the metal fine particles. It is also possible to apply wet etching using a removing solution corresponding to the metal fine particle material. As this removing solution, a solution in which the mask layer, magnetic recording layer, and substrate material to be exposed are sparingly soluble is selected.

The mask layer can have various arrangements by taking account of the etching selectivity to the metal fine particle layer. As described previously, examples are arrangements such as C/Si, Ta/Al, Al/Ni, and Si/Cr from the substrate side.

If the spacings between the metal fine particles are significantly narrow, it is possible to adjust the fine particle spacings by intentionally etching the metal fine particle film. Examples of practical methods are a method of increasing side etch of dry etching, and a method of slimming the metal fine particles in the widthwise direction by adjusting the incident angle of the ion species in ion milling. As described above, the projections pattern can be formed on the resist layer by using the metal fine particle mask.

It is also possible to manufacture a nanoimprint stamper through the steps of multilayered metal fine particle coating→monolayer formation→pattern transfer to the mask layer as described above, and transfer the projections pattern to the magnetic recording layer by nanoimprint lithography.

A stamper manufacturing method according to the embodiment includes steps of

coating a substrate with a metal fine particle coating solution containing metal fine particles and a first solvent, thereby forming a metal fine particle coating layer having a multilayered structure of the metal fine particles,

dropping, on the coating layer, a second solvent having a second solubility parameter having a difference of 0 to 12.0 from a first solubility parameter of the first solvent, thereby washing away excessive metal fine particles, and forming a monolayered metal fine particle film by changing the multilayered structure of the metal fine particles into a monolayer,

forming, on a projections pattern made of the monolayered metal fine particle film, a conductive layer having the projections pattern,

forming an electroformed layer by using the conductive layer as an electrode, and

forming a stamper made of the electroformed layer on which the projections pattern is transferred by removing the conductive layer.

A magnetic recording medium manufacturing method according to the fifth embodiment is a method of manufacturing a magnetic recording medium by nanoimprint lithography by using the above-mentioned stamper, including steps of

coating a substrate with a metal fine particle coating solution containing metal fine particles and a first solvent, thereby forming a metal fine particle coating layer having a multilayered structure of the metal fine particles,

dropping, on the coating layer, a second solvent having a second solubility parameter having a difference of 0 to 12.0 from a first solubility parameter of the first solvent, thereby washing away excessive metal fine particles, and forming a monolayered metal fine particle film by changing the multilayered structure of the metal fine particles into a monolayer,

forming, on a projections pattern made of the monolayered metal fine particle film, a conductive layer having the projections pattern,

forming an electroformed layer by using the conductive layer as an electrode,

forming a stamper made of the electroformed layer on which the projections pattern is transferred by removing the conductive layer,

forming a magnetic recording layer on the substrate,

forming a mask layer on the magnetic recording layer,

forming an imprint resist layer on the mask layer,

transferring the projections pattern to the imprint resist layer by using the stamper,

transferring the projections pattern to the mask layer,

transferring the projections pattern to the magnetic recording layer, and

removing the mask layer from the magnetic recording layer.

In nanoimprint lithography, pattern transfer is performed by pressing a nanoimprint stamper (to be referred to as a stamper hereinafter) having a projections micropattern formed on the surface against a transfer resist layer. Compared to step-and-repeat ultraviolet exposure or electron beam exposure, nanoimprint lithography can transfer a resist pattern to a large area of a sample at once. Since the manufacturing throughput increases, therefore, it is possible to shorten the manufacturing time and reduce the cost.

The stamper can be obtained from a substrate having a projections micropattern, i.e., a so-called master template (mold or template). In many cases, the stamper is manufactured by electroforming the micropattern of the master template. As the substrate of the master template, it is possible to use Si, SiO₂, SiC, SiOC, Si₃N₄, C, or a semiconductor substrate in which an impurity such as B, Ga, In, or P is doped. A substrate made of a conductive material can also be used. Also, the projections shape of the substrate is not limited, so a circular, rectangular, or doughnut-like substrate can be used.

The pattern of the master template can be the projections pattern of the metal fine particles as described previously, and the metal fine particle pattern can also be transferred to the mask layer and applied as an electroforming pattern. In addition, a projections pattern can be transferred to the master template and used as an electroforming pattern.

Subsequently, a stamper is manufactured by electroforming the projections pattern of the master template. Although various materials can be used in electroforming, i.e., as a plating metal, a method of manufacturing an Ni stamper will be explained as an example.

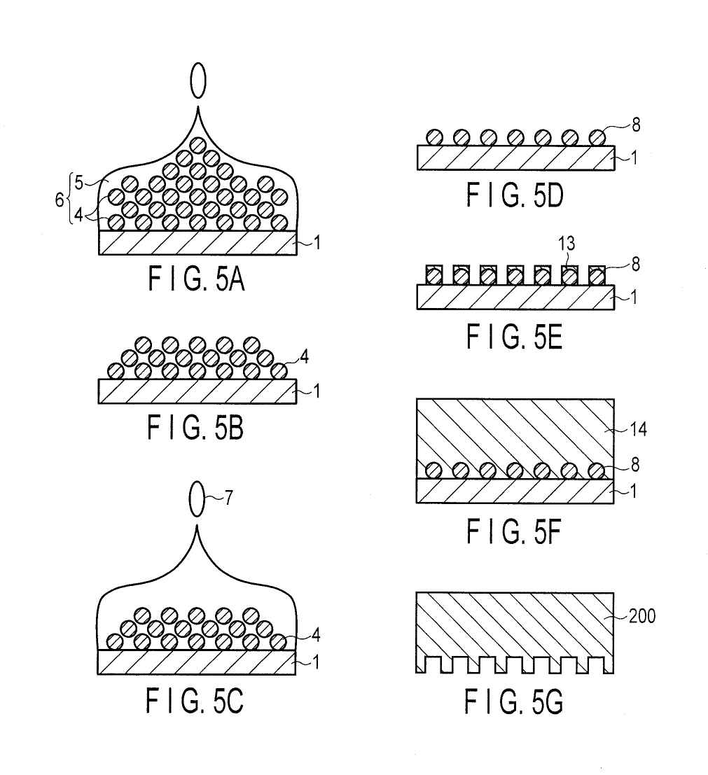

FIGS. 5A, 5B, 5C, 5D, 5E, 5F, and 5G are views showing nanoimprint stamper manufacturing steps.

First, as shown in FIG. 5A, a metal fine particle coating solution is dropped on a substrate 1 to coat it with the solution, thereby forming a metal fine particle coating layer 6 containing metal fine particles 4 and a first solvent 5. Subsequently, multilayered structure of the metal fine particles 4 is formed as shown in FIG. 5B. Then, a rinsing solution 7 is dropped on the multilayered structure of the metal fine particles 4 to coat the structure with the solution as shown in FIG. 5C, and a monolayered metal fine particle film 8 is formed as shown in FIG. 5D. Thus, a master template on which the metal fine particles form a projections pattern is obtained.

Subsequently, as shown in FIG. 5E, a conductive film 13 is deposited on the surface of the monolayered metal fine particle film 8 in order to give conductivity to the projections pattern of the master template. If a conduction defect occurs during electroforming (to be described later), plating growth is obstructed, and this leads to a pattern defect. Therefore, the conductive film 13 can evenly be deposited on the surface and side surfaces of the projections pattern. However, if conductive materials are used as the metal fine particles and substrate, the projections pattern need only have electrical conduction. In this case, the conductive film 13 may be deposited only on the upper portions and side surfaces of the metal fine particles and in the grooves.

The conductive film 13 can be selected from various materials. Examples of the materials of the conductive film 13 are Ni, Al, Ti, C, Au, and Ag. An example using Ni will be explained below.

Note that the conductive film 13 deposited on the metal fine particles can also be integrated with the metal fine particle pattern.

Then, as shown in FIG. 5F, the master template is dipped in an Ni sulfamate bath or NiP bath, and electroforming is performed by supplying an electric current, thereby forming an electroformed layer 14 as a stamper on the conductive film 13. The film thickness after the plating, i.e., the thickness of the stamper can be adjusted by changing, e.g., the hydrogen ion concentration, temperature, and viscosity of the plating bath, the electric current value, and the plating time. This electroforming can be performed by electroplating or electroless plating.

A stamper 200 obtained as described above is released from the substrate 1 as shown in FIG. 5G. If the metal fine particle layer 8 remains on the projections surface of the stamper, it is possible to remove the metal fine particles remaining as a residue and expose the projections pattern by etching the projections surface. It is also possible to perform wet etching using a removing solution in which the stamper 200 is sparingly soluble and the metal fine particles are readily soluble. Finally, the stamper can be completed by mechanically removing unnecessary portions except for the projections pattern surface, and processing the stamper into a desired shape such as a circle or rectangle.

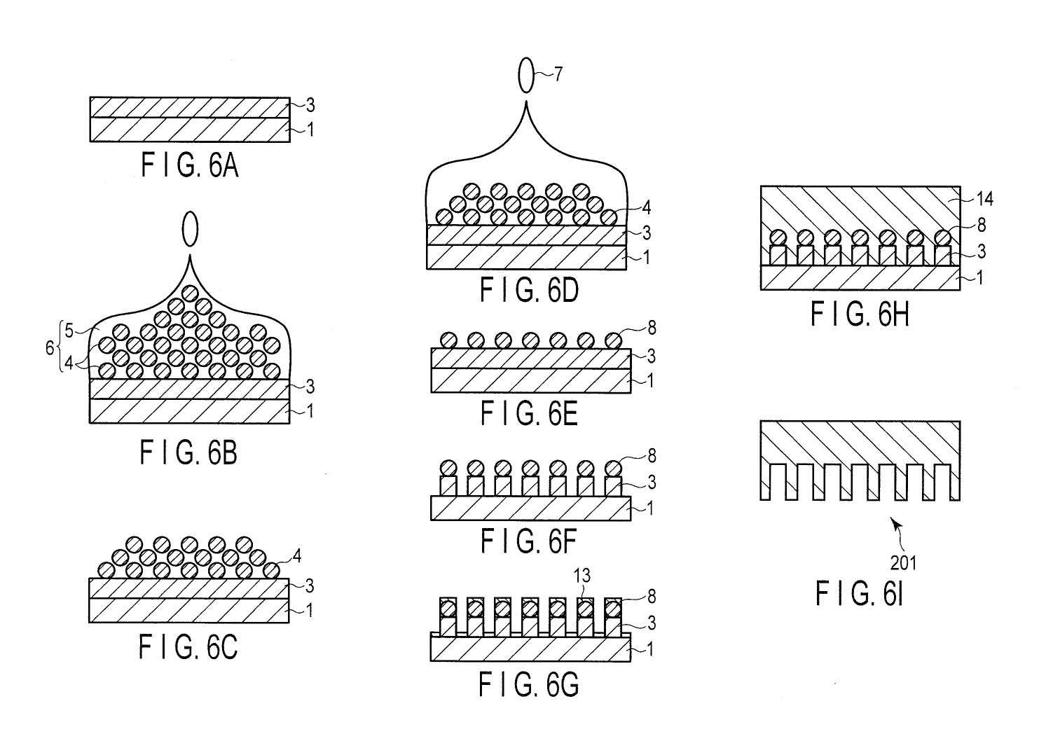

FIGS. 6A, 6B, 6C, 6D, 6E, 6F, and 6G are views showing a modification of the nanoimprint stamper manufacturing steps. In this modification, a mask layer 3 is formed on a substrate 1. These stamper manufacturing steps are the same as the stamper manufacturing steps shown in FIGS. 5A, 5B, 5C, 5D, 5E, 5F, and 5G except that the modification includes a step of dropping a metal fine particle coating solution on the mask layer 3 to coat it with the solution, thereby forming a metal fine particle coating layer 8 as shown in FIG. 6B, a step of forming a multilayered structure of metal fine particles 4 on the mask layer 3 as shown in FIG. 6C, a step of dropping a rinsing solution 7 as shown in FIG. 6D, a step of forming a monolayered metal fine particle film 8 by forming a monolayer of the metal fine particles on the mask layer as shown in FIG. 6E, and a step of transferring a projections pattern to the mask layer 3 by using the monolayered metal fine particle film 8 as a mask pattern as shown in FIG. 6F. As described previously, the mask layer 3 herein used need only be a material capable of securing the etching selectivity to the metal fine particles, and can have a multilayered structure including two or more layers. Furthermore, after the step shown in FIG. 6F, it is also possible to transfer the projections pattern to the substrate 1 via the mask layer 3, and manufacture a stamper by using a master template (not shown) in which the projections structure is transferred to the substrate.

A duplicated stamper can be manufactured by using a stamper in place of a master template. Examples are a method of obtaining an Ni stamper from an Ni stamper, and a method of obtaining a resin stamper from an Ni stamper. In this specification, a method of manufacturing a resin stamper having a relatively high cost performance and easy to manufacture will be explained.

A resin stamper is manufactured by injection molding. First, an Ni stamper is loaded into an injection molding apparatus, and injection molding is performed by supplying a resin solution material to the projections pattern of the stamper. As the resin solution material, it is possible to apply a cycloolefin polymer, polycarbonate, or polymethylmethacrylate, and select a material having a high removability with respect to an imprint resist (to be described later). After the injection molding is performed, a resin stamper having the projections pattern is obtained by releasing the sample from the Ni stamper.

The projections pattern is transferred by using the obtained resin stamper. As described previously, a sample in which a magnetic recording layer and mask layer are formed from the substrate side is used, and a sample in which an imprint resist layer is additionally formed on the mask layer is also used. As the imprint resist, it is possible to use various resist materials such as a thermosetting resin and photosetting resin. Examples are isobornyl acrylate, allyl methacrylate, and dipropyleneglycol diacrylate.

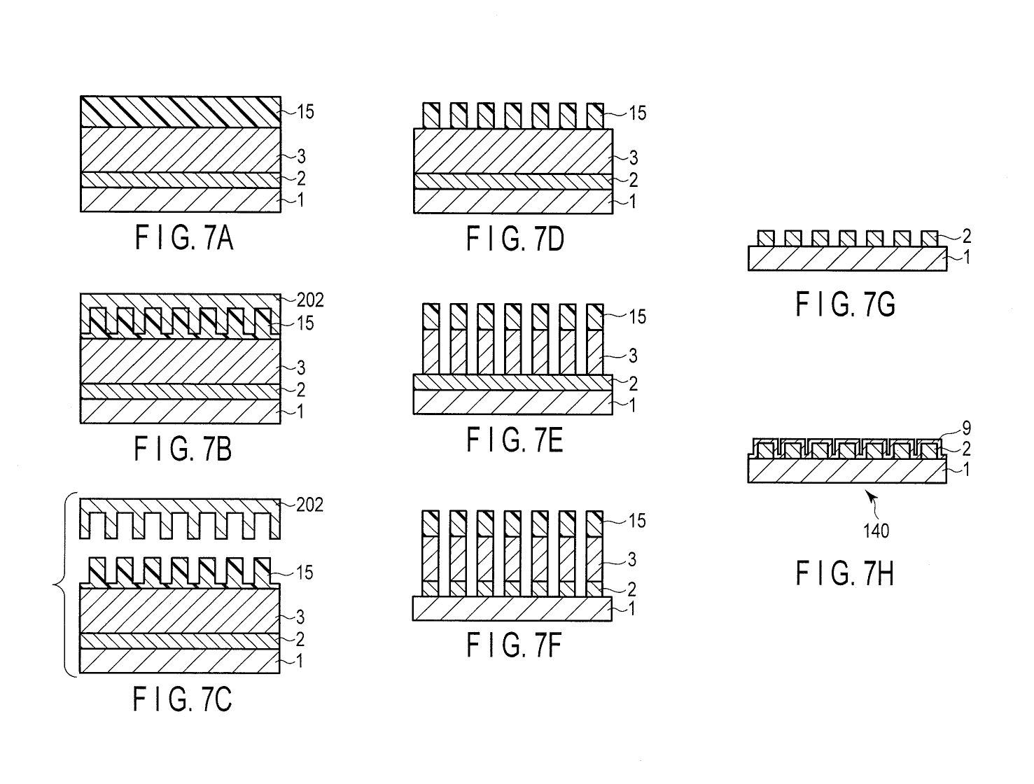

As shown in FIG. 7A, a sample including a magnetic recording layer 2 and mask layer 3 on a substrate 1 is coated with any of these resist materials, thereby forming a resist layer 15. Then, as shown in FIG. 7B, a resin stamper 202 having a projections pattern is imprinted on the resist layer 15. When the resist stamper 202 is pressed against the resist during this imprinting, the resist fluidifies and forms a projections pattern. The resist layer 15 forming the projections pattern is cured by applying energy such as ultraviolet light to the resist layer 15. Then, the projections pattern of the resist layer 15 is obtained by releasing the resin stamper 202. To facilitate releasing the resin stamper 202, a releasing process using a silane coupling agent or the like may also be performed on the surface of the resin stamper 202 beforehand.

Subsequently, as shown in FIG. 7C, the resin stamper 202 pressed against the imprint resist is released. Since the resist material remains as a residue in the recesses of the resist layer 15 after the resin stamper 202 is released, the surface of the mask layer 3 is exposed by etching away the residue as shown in FIG. 7D. The residue can easily be removed by dry etching using O₂ gas, because the polymer-based resist material generally has a low etching resistance against an O₂ etchant. If an inorganic material is contained, an etching gas can properly be changed so that the resist pattern remains. After that, as shown in FIGS. 7E, 7F, 7G, and 7H, the projections pattern is transferred to the mask layer 3 and to the magnetic recording layer 2, and a step of forming a protective film 9 is performed. Consequently, a magnetic recording medium 140 having the projections pattern can be manufactured by nanoimprinting.

### Magnetic Recording Layer Patterning Step

Then, as shown in FIGS. 1G and 4H, the projections pattern is transferred to the magnetic recording layer 2 below the alloy release layer 12.

A typical method of forming magnetically isolated dots is the above-mentioned reactive ion etching or milling. More specifically, patterning can be performed by reactive ion etching using CO or NH₃ as an etching gas, or ion milling using an inert gas such as He, Ne, Ar, Xe, or Kr.

When patterning the magnetic recording layer, the relationship between an etching rate ERₘₐₛₖ of the mask layer and an etching rate ER_{mag} of the magnetic recording layer can satisfy ERₘₐₛₖ≦ER_{mag}. That is, to obtain a desired magnetic recording layer thickness, it is preferable to minimize the reduction in amount of the mask layer caused by etching.

When transferring the projections structure to the magnetic recording layer by ion milling, it is necessary to suppress a byproduct, i.e., a so-called redeposition component that scatters toward the mask sidewalls as the processing advances. Since this redeposition component adheres around the projecting pattern mask, the projecting patterns increase the dimensions and fill the grooves. To obtain divided magnetic recording layer patterns, therefore, it is possible to reduce the redeposition component as soon as possible. Also, if the redeposition component produced when the magnetic recording layer below the release layer is etched covers the side surfaces of the release layer, the release layer is not exposed to the removing solution any longer, and the removability deteriorates. Accordingly, the redeposition component can be reduced.

When performing ion milling on the magnetic recording layer, the redeposition component on the sidewalls can be reduced by changing the ion incident angle. Although an applicable incident angle changes in accordance with the mask height, redeposition can be suppressed within the range of 20° to 70°. Also, the incident angle can appropriately be changed during milling. An example is a method in which after the magnetic recording layer is milled at an ion incident angle of 0°, the redeposition component on the projecting patterns is selectively removed by changing the ion incident angle.

### Mask Layer Removing Step

Subsequently, as shown in FIGS. 1H and 4I, the mask pattern on the magnetic recording layer 2 is removed, thereby obtaining the magnetic recording layer 2 having the projections pattern.

When performing the removal by dry etching, it is possible to reduce chemical modification on the magnetic recording layer surface, and perform etching so as not to reduce the magnetic recording layer thickness.

When dissolving the release layer by wet etching, the dissolving rate of the magnetic recording layer and substrate can be made much lower than that of the release layer.

When performing dry etching by using a chemically active gas, the removability can be improved by modifying the surface again by exposure to the active gas species. For example, if the release layer surface is oxidized by excess exposure to oxygen plasma, the removability of the release layer can be maintained by promoting a redox reaction by exposing the surface to hydrogen plasma again. It is also possible to modify the release layer side surfaces by washing using a solution. For example, when a fluoride sticking to the release layer side surfaces after exposure to fluorine plasma is washed with water, it is possible to remove the fluoride and clean the release layer surface.

Furthermore, in the fourth embodiment as shown in FIGS. 4A, 4B, 4C, 4D, 4E, 4F, 4G, 4H, 4I, and 4J, the mask layer on the magnetic recording layer can be removed by removing the release layer formed on the magnetic recording layer. This removal can be performed by either dry etching described above or wet etching.

### Protective Layer Formation Step

Finally, a magnetic recording medium having the projections pattern can be obtained by depositing a carbon-based protective layer and a fluorine-based lubricating film (not shown) on the magnetic recording layer pattern having the projections structure.

As the carbon protective layer, a DLC film containing a large amount of sp³-bonded carbon can be used. The film thickness of the protective layer can be set to 2 nm or more in order to maintain the coverage, and 10 nm or less in order to maintain the signal S/N. Also, perfluoropolyether, alcohol fluoride, or fluorinated carboxylic acid can be used as a lubricant.

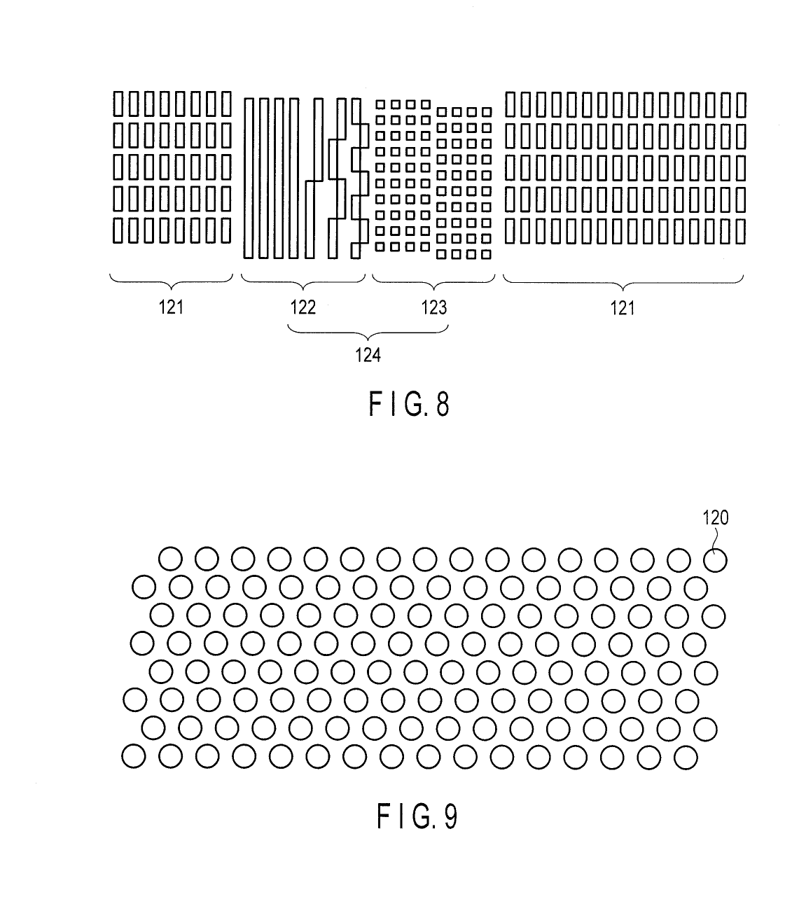

FIG. 8 is a view showing examples of recording bit patterns in the circumferential direction of the magnetic recording medium.

As shown in FIG. 8, the projecting patterns of the magnetic recording layer are roughly classified into a recording bit area 121 for recording data corresponding to 1 and 0 of digital signals, and a so-called servo area 124 including a preamble address pattern 122 as a magnetic head positioning signal, and a burst pattern 123. These patterns can be formed as in-plane patterns. Also, the patterns in the servo area shown in FIG. 8 need not have rectangular shapes. For example, all the servo patterns may also be replaced with dot-like patterns.

FIG. 9 is a view showing an example of the dot pattern used in the embodiment.

Furthermore, as shown in FIG. 9, not only the servo area but also the data area can entirely be formed by a dot pattern 120. One-bit information can be formed by one magnetic dot or a plurality of magnetic dots.

FIG. 10 is a partially exploded perspective view showing an example of a magnetic recording/reproduction apparatus to which the magnetic recording medium according to the embodiment is applicable. As a disk apparatus, FIG. 10 shows the internal structure of a hard disk drive (HDD) according to the embodiment by removing its top cover. As shown in FIG. 10, the HDD includes a housing 210. The housing 210 includes a rectangular boxy base 211 having an open upper end, and a rectangular plate-like top cover (not shown). The top cover is fixed to the base by a plurality of screws, and closes the open upper end of the base. Consequently, the interior of the housing 210 is airtightly held, and can communicate with the outside through only a breathing filter 226.

A magnetic disk 212 as a recording medium and a driving unit are arranged on the base 211. The driving unit includes a spindle motor 213 for supporting and rotating the magnetic disk 212, a plurality of, e.g., two magnetic heads 233 for performing information recording and reproduction on the magnetic disk, a head actuator 214 for supporting the magnetic heads 233 such that the magnetic heads 233 can freely move over the surface of the magnetic disk 212, and a voice coil motor (to be referred to as a VCM hereinafter) 216 for pivoting and positioning the head actuator. A ramped loading mechanism 218, inertia latch 220, and substrate unit 217 are also arranged on the base 211. The ramped loading mechanism 218 holds the magnetic heads 233 in a position separated from the magnetic disk 212 when the magnetic heads 233 have moved to the outermost circumference of the magnetic disk 212. The inertia latch 220 holds the head actuator 214 in a retracted position when an impact or the like acts on the HDD. The substrate unit 217 includes electronic parts such as a preamplifier and head IC.

A control circuit board 225 is screwed to the outer surface of the base 211, and faces the bottom wall of the base 211. The control circuit board 225 controls the operations of the spindle motor 213, VCM 216, and magnetic heads 233 via the substrate unit 217.

Referring to FIG. 10, the magnetic disk 212 is formed as a perpendicular magnetic recording medium having projections patterns formed by the above-described processing method. Also, as described previously, the magnetic disk 212 has a substrate 219 made of a disk-like nonmagnetic member having a diameter of about 2.5 inches. On each surface of the substrate 219, a soft magnetic layer 223 as an underlayer and a perpendicular magnetic recording layer 222 having magnetic anisotropy perpendicular to the disk surface are sequentially stacked. A protective film 224 is formed on the perpendicular magnetic recording layer 222.

Also, the magnetic disk 212 is coaxially fitted on a hub of the spindle motor 213 and fixed to the hub by being clamped by a clamp spring 221 screwed to the upper end of the hub. The spindle motor 213 as a driving motor rotates the magnetic disk 212 at a predetermined speed in the direction of an arrow B.

The head actuator 214 includes a bearing 215 fixed on the bottom wall of the base 211, and a plurality of arms 227 extending from the bearing. The arms 227 are arranged parallel to the surface of the magnetic disk 212 and spaced apart from each other by a predetermined distance, and extend in the same direction from the bearing 215. The head actuator 214 includes elastically deformable narrow plate-like suspensions 230. The suspensions 230 are formed by leaf springs, and have proximal end portions fixed to the distal end portions of the arms 227 by spot welding or adhesion and extending from the arms. The magnetic heads 233 are supported by the extended ends of the suspensions 230 via gimbal springs 241. The suspensions 230, gimbal springs 241, and magnetic heads 233 form a head gimbal assembly. Note that the head actuator 214 may also have a so-called E block formed by integrating a sleeve of the bearing 215 and a plurality of arms.

A drive having a high recording density and high signal S/N is obtained by applying the above-described magnetic recording medium having a projections structure to the magnetic recording/reproduction apparatus.

### EXAMPLES

The embodiments will be explained in more detail below by way of its examples.

### Example 1

Example 1 is a process of forming a magnetic recording layer, mask layer, and metal fine particle layer on a substrate, and transferring a projections pattern to the magnetic recording layer.

A 2.5-inch doughnut substrate was used as the substrate, and a magnetic recording layer was formed on the substrate by DC sputtering. This magnetic recording layer was obtained by sequentially forming a 10-nm thick NiTa underlayer/4-nm thick Pd underlayer/20-nm thick Ru underlayer/5-nm thick CoPt recording layer from the substrate side, and finally forming a 3-nm thick Pd protective layer, by using Ar as a process gas at a gas pressure of 0.7 Pa, a gas flow rate of 35 sccm, and an input power of 500 W.

Subsequently, a mask layer was formed on the Pd protective layer. In this example, three mask layers were used in order to precisely transfer the projections pattern of the metal fine particle layer. That is, 30-nm thick C as a first mask layer, 5-nm thick Si as an upper transfer layer, and 3-nm thick C as a third mask layer were formed from the substrate side. Each mask layer was deposited by sputtering by using a facing-target DC sputtering apparatus at an Ar gas flow rate of 35 sccm, an Ar gas pressure of 0.7 Pa, and an input power of 500 W.

Then, a coating solution for forming a metal fine particle mask was prepared. As this coating solution, a solution mixture containing a metal fine particle dispersion and polymer binder was used.

As the metal fine particles, Au having a surface covered with an alkane thiol group and having an average particle size of 8 nm was used. Polystyrene having an average molecular weight of 2,800 was used as the polymer binder and mixed in the metal fine particles such that Au:polystyrene=2:3 as a weight ratio. Also, toluene was used as a first solvent and diluted so that the concentration was 1.5 wt %, thereby preparing a solution. Finally, the metal fine particle solution was dispersed by using an ultrasonic dispersion apparatus, thereby preparing the coating solution by promoting the monodispersion of the fine particles.

Then, a metal fine particle layer was formed on the C film. A proper amount of the prepared metal fine particle coating solution was dropped on the C film, and spin coating was performed at a rotational speed of 2,500 rpm, thereby obtaining three metal fine particle layers on the substrate.

Subsequently, a monolayer of the metal fine particles was formed by coating the multiple metal fine particle layers with a second solvent. In this example, propyleneglycol monomethyletheracetate was used as the second solvent.

The coating of the second solvent was performed by spin coating described previously. That is, after a proper amount of the second solvent was dropped on the multiple metal fine particle layers, a metal fine particle monolayer was formed on the substrate by performing spin coating at a rotational speed of 5,000 rpm.

FIGS. 11A and 11B are exemplary model views showing a step of obtaining a monolayered metal fine particle film from a metal fine particle resist layer.

As shown in FIG. 11A, a multilayered structure of metal fine particles 4 was formed in a metal fine particle resist layer formed on a mask layer 3 by spin coating. When using a doughnut-like, disk-like magnetic recording medium, the number of layers of this multilayered structure in the outer circumference is larger than that in the inner circumference. By contrast, as shown in FIG. 11B, the metal fine particles are regularly arranged in a monolayered metal fine particle film 8.

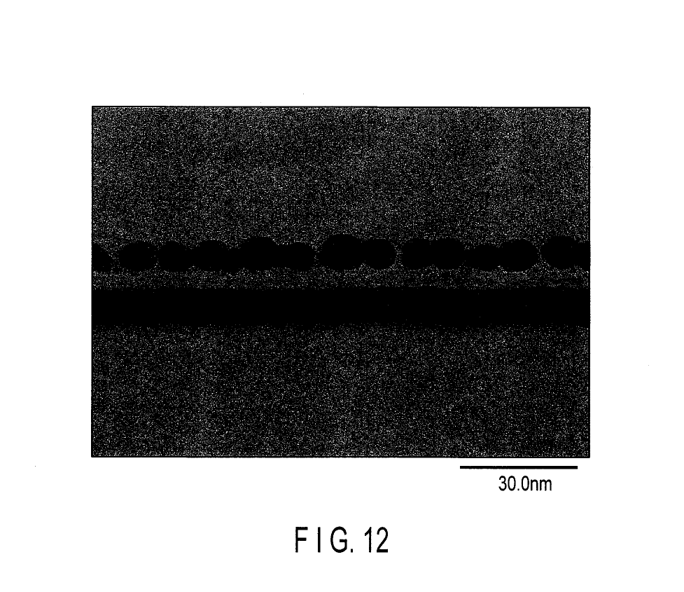

FIG. 12 is a view showing a sectional image of the metal fine particle layer according to the embodiment.

When the sectional shape of this sample was observed with a TEM, a fine particle monolayer in which dots were isolated from each other was formed as shown in FIG. 12.

Projections pattern transfer to the mask layer was performed by dry etching. In this dry etching, inductively coupled plasma etching using CF₄ gas and O₂ gas was applied. First, the projections pattern was transferred to the C film in the lower portion of the metal fine particle mask layer by performing etching for 25 sec by using O₂ gas as an etchant at a pressure of 0.1 Pa, a gas flow rate of 20 sccm, an input power of 40 W, and a bias power of 10 W.

Then, the projections pattern was transferred to the Si film as the lower layer by performing etching for 32 sec at a CF₄ gas pressure of 0.1 Pa, a gas flow rate of 20 sccm, an input power of 50 W, and a bias power of 5 W. Subsequently, the projections pattern was transferred by etching the C mask layer as the lower layer for 65 sec by using O₂ gas at a gas pressure of 0.1 Pa, a gas flow rate of 20 sccm, an input power of 40 W, and a bias power of 20 W.

After that, the projections pattern was transferred to the magnetic recording layer. In this example, milling using Ar ions was applied. The projections pattern was transferred to the 5-nm thick CoPt recording layer/3-nm thick Pd layer by performing milling for 65 sec at an Ar ion acceleration voltage of 300 V, a gas flow rate of 3 sccm, and a process pressure of 0.1 Pa, by setting the ion species incident angle to the substrate surface at 90° (perpendicular incidence). Also, the mask layer remaining on the magnetic recording layer was removed by performing milling for 5 sec at an Ar ion acceleration voltage of 100 V, a gas flow rate of 3 sccm, and a process pressure of 0.1 Pa, by setting the ion species incident angle to the substrate surface at 90° (perpendicular incidence).

Finally, a 2-nm thick DLC film was deposited, and a 1.5-nm thick perfluoropolyether-based lubricating film was formed after that, thereby obtaining a magnetic recording medium having the projections pattern.

A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium.

Finally, to evaluate the recording/reproduction characteristic of the medium, the electromagnetic conversion characteristic was measured by using the read-write analyzer RWA1632 and spinstand S1701MP manufactured by GUZIK, U.S.A. That is, to evaluate the recording/reproduction characteristic, the signal-to-noise ratio (SNR) of the medium was measured at a linear recording density of 1,200 kBPI as a recording frequency condition, by using a head including a shielded magnetic pole as a single magnetic pole having a shield (this shield has a function of converging an output magnetic flux from the magnetic head) as a write unit, and a TMR element as a reproduction unit. As a consequence, it was possible to obtain 12.4 dB as the SNR value of the medium.

### Example 2

Example 2 is the same as Example 1 except that Si was used as a pattern transfer layer between the mask layer and metal fine particle layer.

Si as the pattern transfer layer was formed by DC sputtering. That is, 3-nm thick Si was formed by using Ar as a process gas at a gas pressure of 0.7 Pa, a gas flow rate of 35 sccm, and an input power of 500 W. Consequently, a four-layered mask including 30-nm thick C/5-nm thick Si/3-nm thick C/3-nm thick Si was formed on the magnetic recording layer.

The Si transfer layer was processed by dry etching as described earlier. That is, the 3-nm thick Si transfer layer was processed by performing etching for 9 sec by using CF₄ as an etchant at a gas pressure of 0.1 Pa, a gas flow rate of 20 sccm, an input power of 50 W, and a bias power of 5 W.

After that, a magnetic recording medium having a projections shape was obtained by transferring a projections pattern to the mask layer and magnetic recording layer in the same manner as in Example 1. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.8 dB as the SNR value of the medium.

### Example 3

Example 3 is the same as Example 2 except that C having an average particle size of 8.2 nm was used as the metal fine particles.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.6 dB as the SNR value of the medium.

### Example 4

Example 4 is the same as Example 2 except that Al having an average particle size of 15.3 nm was used as the metal fine particles.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.2 dB as the SNR value of the medium.

### Example 5

Example 5 is the same as Example 2 except that Si having an average particle size of 19.8 nm was used as the metal fine particles.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.4 dB as the SNR value of the medium.

### Example 6

Example 6 is the same as Example 2 except that Ti having an average particle size of 19.3 nm was used as the metal fine particles.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.2 dB as the SNR value of the medium.

### Example 7

Example 7 is the same as Example 2 except that Fe₂O₃ having an average particle size of 20 nm was used as the metal fine particles.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.4 dB as the SNR value of the medium.

### Example 8

Example 8 is the same as Example 2 except that Co having an average particle size of 17.5 nm was used as the metal fine particles.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.8 dB as the SNR value of the medium.

### Example 9

Example 9 is the same as Example 2 except that Ni having an average particle size of 15.5 nm was used as the metal fine particles.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 13 dB as the SNR value of the medium.

### Example 10

Example 10 is the same as Example 2 except that Cu having an average particle size of 6.8 nm was used as the metal fine particles.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.4 dB as the SNR value of the medium.

### Example 11

Example 11 is the same as Example 2 except that Zn having an average particle size of 17.4 nm was used as the metal fine particles.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.2 dB as the SNR value of the medium.

### Example 12

Example 12 is the same as Example 2 except that Zr having an average particle size of 15.3 nm was used as the metal fine particles.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.6 dB as the SNR value of the medium.

### Example 13

Example 13 is the same as Example 2 except that Mo having an average particle size of 12.7 nm was used as the metal fine particles.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.8 dB as the SNR value of the medium.

### Example 14

Example 14 is the same as Example 2 except that Ru having an average particle size of 19.9 nm was used as the metal fine particles.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.3 dB as the SNR value of the medium.

### Example 15

Example 15 is the same as Example 2 except that PdSi having an average particle size of 18.9 nm was used as the metal fine particles.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.1 dB as the SNR value of the medium.

### Example 16

Example 16 is the same as Example 2 except that Ag having an average particle size of 9.7 nm was used as the metal fine particles.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 13 dB as the SNR value of the medium.

### Example 17

Example 17 is the same as Example 2 except that Ta having an average particle size of 15.3 nm was used as the metal fine particles.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 11.8 dB as the SNR value of the medium.

### Example 18

Example 18 is the same as Example 2 except that W having an average particle size of 10.8 nm was used as the metal fine particles.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12 dB as the SNR value of the medium.

### Example 19

Example 19 is the same as Example 2 except that Pt having an average particle size of 18 nm was used as the metal fine particles.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 11.9 dB as the SNR value of the medium.

### Example 20

Example 20 is the same as Example 2 except that Ce having an average particle size of 19.9 nm was used as the metal fine particles.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.4 dB as the SNR value of the medium.

### Example 21

Example 21 is the same as Example 2 except that xylene was used as the second solvent.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.8 dB as the SNR value of the medium.

### Example 22

Example 22 is the same as Example 2 except that tetradecane was used as the second solvent.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 11.3 dB as the SNR value of the medium.

### Example 23

Example 23 is the same as Example 2 except that hexane was used as the second solvent.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.3 dB as the SNR value of the medium.

### Example 24

Example 24 is the same as Example 2 except that tetrahydrofuran was used as the second solvent.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.5 dB as the SNR value of the medium.

### Example 25

Example 25 is the same as Example 2 except that PGMEA was used as the first solvent and toluene was used as the second solvent.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 11.8 dB as the SNR value of the medium.

### Example 26

Example 26 is the same as Example 2 except that xylene was used as the first solvent and toluene was used as the second solvent.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 11.9 dB as the SNR value of the medium.

### Example 27

Example 27 is the same as Example 2 except that tetradecane was used as the first solvent and toluene was used as the second solvent.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.6 dB as the SNR value of the medium.

### Example 28

Example 28 is the same as Example 2 except that hexane was used as the first solvent and toluene was used as the second solvent.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.8 dB as the SNR value of the medium.

### Example 29

Example 29 is the same as Example 2 except that tetrahydrofuran was used as the first solvent and toluene was used as the second solvent.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.4 dB as the SNR value of the medium.

### Example 30

Example 30 is the same as Example 2 except that water was used as the first solvent and ethanol was used as the second solvent.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.2 dB as the SNR value of the medium.

### Example 31

Example 31 is the same as Example 2 except that water was used as the first solvent and isopropanol was used as the second solvent.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12 dB as the SNR value of the medium.

### Example 32

Example 32 is the same as Example 2 except that water was used as the first solvent and formamide was used as the second solvent.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 11.4 dB as the SNR value of the medium.

### Example 33

Example 33 is the same as Example 2 except that ethanol was used as the first solvent and water was used as the second solvent.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.8 dB as the SNR value of the medium.

### Example 34

Example 34 is the same as Example 2 except that isopropanol was used as the first solvent and water was used as the second solvent.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.3 dB as the SNR value of the medium.

### Example 35

Example 35 is the same as Example 2 except that formamide was used as the first solvent and water was used as the second solvent.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.8 dB as the SNR value of the medium.

### Example 36

Example 36 is the same as Example 2 except that toluene was used as the first and second solvents.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 10.2 dB as the SNR value of the medium.

### Example 37

Example 37 is the same as Example 2 except that water was used as the first and second solvents.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 10.8 dB as the SNR value of the medium.

### Example 38

In Example 38, a nanoimprint stamper was manufactured by using a substrate on which metal fine particles were patterned as a master template, and a projections pattern was formed by nanoimprint lithography using the nanoimprint stamper. This example is the same as Example 2 except that toluene was used as the first solvent, PGMEA was used as the second solvent, and a projections structure was formed on a magnetic recording medium by using the nanoimprint stamper.

First, a master template was manufactured in order to manufacture a nanoimprint stamper. A general-purpose, 6-inch Si wafer was used as a substrate, and a 30-nm thick carbon mask layer/6-nm thick Si transfer layer were formed from the substrate side in the same manner as in Example 1. Then, a monolayered projections pattern was obtained by coating the substrate with Au fine particles having an average particle size of 8 nm in the same manner as in Example 1.

A nanoimprint stamper was manufactured by using this master template. First, an Ni film was deposited by DC sputtering in order to make the projections pattern conductive. That is, the projections pattern was evenly covered with a 2-nm thick Ni conductive film at an ultimate vacuum degree of 8.0×10⁻⁴ Pa, an Ar gas pressure of 1.0 Pa, and a DC input power of 200 W. As the conductive film formation method, it is also possible to use vapor deposition, or an Ni—P alloy or Ni—B alloy formed by electroless plating, instead of sputtering. Furthermore, in order to facilitate the release of the stamper, the surface may also be oxidized after the conductive film is formed.

Subsequently, an Ni film was electroformed along the projections pattern. As the electroforming solution, a high-concentration nickel sulfamate plating solution (NS-169) available from SHOWA CHEMICAL was used. A 300-μm thick Ni stamper was manufactured by using 600 g/L of nickel sulfamate, 40 g/L of boric acid, and 0.15 g/L of a sodium lauryl sulfate surfactant at a solution temperature of 55° C., a pH of 3.8 to 4.0, and an electric current density of 20 A/dm². A nanoimprint stamper having the projections pattern is obtained by releasing this Ni stamper from the master template. If the residue or particles remain on the projections 1 pattern of the released stamper, etching is performed on the projections pattern as needed. Consequently, the stamper can be cleaned by removing the residue or particles. Finally, the electroformed Ni plate was punched into a 2.5-inch disk shape, thereby obtaining an Ni stamper.

A resin stamper was duplicated by performing an injection molding process on this Ni stamper. As the resin material, a cyclic olefin polymer (ZEONOR 1060R) available from ZEON was used.

A projections pattern was formed on a resist layer by using the resin stamper obtained as described above. First, a medium sample was spin-coated with a 40-nm thick ultraviolet-curing resist, thereby forming a resist layer. Subsequently, the resin stamper was imprinted on the resist layer, and the resist layer was cured by ultraviolet irradiation (ultraviolet light was radiated while the resin stamper was pressed against the ultraviolet-curing resin layer). A desired dot pattern was obtained by releasing the resin stamper from the cured resist layer.

The resist residue formed by imprinting in the grooves of the projections pattern of the sample was removed by etching. This resist residue removal was performed by plasma etching using an O₂ etchant. The resist residue was removed by performing etching for 8 sec at an O₂ gas flow rate of 5 sccm, a pressure of 0.1 Pa, an input power of 100 W, and a bias power of 10 W.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.4 dB as the SNR value of the medium.

### Example 39

Example 39 is the same as Example 1 except that an Mo layer was formed as a release layer before the mask layer was formed on the Pd protective layer.

Mo as the release layer was formed by DC sputtering. That is, 5-nm thick Mo was formed by using Ar as a process gas at a gas pressure of 0.7 Pa, a gas flow rate of 35 sccm, and an input power of 500 W. Consequently, a four-layered mask including 5-nm thick Mo/30-nm thick C/5-nm thick Si/3-nm thick C was formed on the magnetic recording layer.

The Mo release layer was processed by Ar ion milling. This processing was performed using Ar as an ion source at an acceleration voltage of 300 V.

After that, the projections pattern was transferred to the mask layer, release layer, and magnetic recording layer in the same manner as in Example 1, and the sample was dipped in a hydrogen peroxide solution having a mass percent concentration of 1% for 5 min and washed with pure water. As a consequence, the mask layer was removed together with the release layer, and a magnetic recording medium having a projections shape was obtained. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.8 dB as the SNR value of the medium.

### Example 40

Example 40 is the same as Example 39 except that an Mo layer was formed as a release layer before the mask layer was formed on the Pd protective layer, and an Si transfer layer was formed on the mask layer.

Si as the transfer layer was formed by DC sputtering. That is, a 3-nm thick Si transfer layer was obtained by using Ar as a process gas at a gas pressure of 0.7 Pa, a gas flow rate of 35 sccm, and an input power of 500 W.

This Si transfer layer was processed by dry etching using CF₄ gas in the same manner as in Example 2. A metal fine particle projections pattern was transferred to the Si transfer layer by performing etching for 32 sec at a process gas pressure of 0.1 Pa, a gas flow rate of 20 sccm, an antenna power of 50 W, and a bias power of 5 W.

After that, a magnetic recording medium having a projections shape was obtained by transferring the projections pattern to the mask layer and magnetic recording layer in the same manner as in Example 39. A head floating amount with respect to the obtained magnetic recording medium was measured by a glide height tester, thereby evaluating the floating characteristic. Consequently, it was possible to pass a floating amount of 10 nm as a standard necessary to evaluate the read/write characteristic of the medium. In addition, the signal-to-noise ratio of the medium was measured using a spinstand. As a consequence, it was possible to obtain 12.5 dB as the SNR value of the medium.

### Comparative Example 1

Comparative Example 1 is the same as Example 2 except that toluene was used as the first solvent and water was used as the second solvent.

After the substrate was coated with the metal fine particles, the surface shape was observed with scanning electron microscope. Consequently, when the rotational speed of coating was low, a hierarchical structure in which the inner, middle, and outer circumferences of the substrate had different steps was formed. When the rotational speed of coating was high, a 0-layer region where no metal fine particle existed was formed.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, projections on the medium surface hit the head an extremely large number of times, and it was impossible to pass a floating amount of 10 nm as a standard necessary to evaluate the read/write characteristic of the medium. In addition, the signal-to-noise ratio of the medium was measured using a spinstand. As a consequence, the SNR value of the medium was 6.5 dB, i.e., lower than those of the examples.

### Comparative Example 2

Comparative Example 2 is the same as Example 2 except that toluene was used as the first solvent and ethanol was used as the second solvent.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, projections on the medium surface hit the head an extremely large number of times, and it was impossible to pass a floating amount of 10 nm as a standard necessary to evaluate the read/write characteristic of the medium. In addition, the signal-to-noise ratio of the medium was measured using a spinstand. As a consequence, the SNR value of the medium was 5.9 dB, i.e., lower than those of the examples.

### Comparative Example 3

Comparative Example 3 is the same as Example 2 except that water was used as the first solvent and toluene was used as the second solvent.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, projections on the medium surface hit the head an extremely large number of times, and it was impossible to pass a floating amount of 10 nm as a standard necessary to evaluate the read/write characteristic of the medium. In addition, the signal-to-noise ratio of the medium was measured using a spinstand. As a consequence, the SNR value of the medium was 6.2 dB, i.e., lower than those of the examples.

### Comparative Example 4

Comparative Example 4 is the same as Example 2 except that ethanol was used as the first solvent and toluene was used as the second solvent.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, projections on the medium surface hit the head an extremely large number of times, and it was impossible to pass a floating amount of 10 nm as a standard necessary to evaluate the read/write characteristic of the medium. In addition, the signal-to-noise ratio of the medium was measured using a spinstand. As a consequence, the SNR value of the medium was 6 dB, i.e., lower than those of the examples.

### Comparative Example 5

Comparative Example 5 is the same as Example 2 except that toluene was used as the first solvent and no second solvent was used.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, projections on the medium surface hit the head an extremely large number of times, and it was impossible to pass a floating amount of 12 nm. In addition, the signal-to-noise ratio of the medium was measured using a spinstand. As a consequence, the SNR value of the medium was 4.8 dB, i.e., lower than those of the examples.

### Comparative Example 6

Comparative Example 6 is the same as Example 2 except that water was used as the first solvent and no second solvent was used.

After that, a magnetic recording medium having a projections shape was obtained by transferring a projections pattern to the mask layer and magnetic recording layer in the same manner as in Example 2. A head floating amount with respect to the obtained magnetic recording medium was measured by a glide height tester, thereby evaluating the floating characteristic. Consequently, projections on the medium surface hit the head an extremely large number of times, and it was impossible to pass a floating amount of 12 nm. In addition, the signal-to-noise ratio of the medium was measured using a spinstand. As a consequence, the SNR value of the medium was 3.9 dB, i.e., lower than those of the examples.

Tables 2 and 3 below show the results of the above-mentioned examples and comparative examples.

TABLE 2

| | | | | | | | | Target of |
|---|---|---|---|---|---|---|---|---|
| | | | | | SP value | Glide evaluation | | three-dimensional |
| | | Microparticle | First solvent | Second solvent | difference | result | SNR (dB) | pattern transfer |
| Example | 1 | Au | Toluene | PGMEA | 1.6 | 10 nm floating pass | 12.4 | Mask layer alone |
| | 2 | Au | Toluene | PGMEA | 1.6 | 10 nm floating pass | 12.8 | Mask/transfer layer |
| | 3 | C | Toluene | PGMEA | 1.6 | 10 nm floating pass | 12.6 | ″ |
| | 4 | Al | Toluene | PGMEA | 1.6 | 10 nm floating pass | 12.2 | ″ |
| | 5 | Si | Toluene | PGMEA | 1.6 | 10 nm floating pass | 12.4 | ″ |
| | 6 | Ti | Toluene | PGMEA | 1.6 | 10 nm floating pass | 12.2 | ″ |
| | 7 | Fe₂O₃ | Toluene | PGMEA | 1.6 | 10 nm floating pass | 12.4 | ″ |
| | 8 | Co | Toluene | PGMEA | 1.6 | 10 nm floating pass | 12.8 | ″ |
| | 9 | Ni | Toluene | PGMEA | 1.6 | 10 nm floating pass | 13 | ″ |
| | 10 | Cu | Toluene | PGMEA | 1.6 | 10 nm floating pass | 12.4 | ″ |
| | 11 | Zn | Toluene | PGMEA | 1.6 | 10 nm floating pass | 12.2 | ″ |
| | 12 | Zr | Toluene | PGMEA | 1.6 | 10 nm floating pass | 12.6 | ″ |
| | 13 | Mo | Toluene | PGMEA | 1.6 | 10 nm floating pass | 12.8 | ″ |
| | 14 | Ru | Toluene | PGMEA | 1.6 | 10 nm floating pass | 12.3 | ″ |
| | 15 | PdSi | Toluene | PGMEA | 1.6 | 10 nm floating pass | 12.1 | ″ |
| | 16 | Ag | Toluene | PGMEA | 1.6 | 10 nm floating pass | 13 | ″ |
| | 17 | Ta | Toluene | PGMEA | 1.6 | 10 nm floating pass | 11.8 | ″ |
| | 18 | W | Toluene | PGMEA | 1.6 | 10 nm floating pass | 12 | ″ |
| | 19 | Pt | Toluene | PGMEA | 1.6 | 10 nm floating pass | 11.9 | ″ |
| | 20 | Ce | Toluene | PGMEA | 1.6 | 10 nm floating pass | 12.4 | ″ |
| | 21 | Au | Toluene | Xylene | 0.3 | 10 nm floating pass | 12.8 | ″ |
| | 22 | Au | Toluene | Tetradecane | 1.2 | 10 nm floating pass | 11.3 | ″ |
| | 23 | Au | Toluene | Hexane | 1.5 | 10 nm floating pass | 12.3 | ″ |
| | 24 | Au | Toluene | Tetrahydrofuran | 0.2 | 10 nm floating pass | 12.5 | ″ |
| | 25 | Au | PGMEA | Toluene | 1.6 | 10 nm floating pass | 11.8 | ″ |
| | 26 | Au | Xylene | Toluene | 0.3 | 10 nm floating pass | 11.9 | ″ |
| | 27 | Au | Tetradecane | Toluene | 1.2 | 10 nm floating pass | 12.6 | ″ |
| | 28 | Au | Hexane | Toluene | 1.5 | 10 nm floating pass | 12.8 | ″ |
| | 29 | Au | Tetrahydrofuran | Toluene | 0.2 | 10 nm floating pass | 12.4 | ″ |
| | 30 | Au | Water | Ethanol | 10.7 | 10 nm floating pass | 12.2 | ″ |
| | 31 | Au | Water | Isopropanol | 11.9 | 10 nm floating pass | 12 | ″ |
| | 32 | Au | Water | Formamide | 4.2 | 10 nm floating pass | 11.4 | ″ |
| | 33 | Au | Ethanol | Water | 10.7 | 10 nm floating pass | 12.8 | ″ |
| | 34 | Au | Isopropanol | Water | 11.9 | 10 nm floating pass | 12.3 | ″ |
| | 35 | Au | Formamide | Water | 4.2 | 10 nm floating pass | 12.8 | ″ |
| | 36 | Au | Toluene | Toluene | 0 | 10 nm floating pass | 10.2 | ″ |
| | 37 | Au | Water | Water | 0 | 10 nm floating pass | 10.8 | ″ |
| | 38 | Au | Toluene | PGMEA | 1.6 | 10 nm floating pass | 12.4 | Stamper |
| | 39 | Au | Toluene | PGMEA | 1.6 | 10 nm floating pass | 12.8 | Release layer/mask |
| | 40 | Au | Toluene | PGMEA | 1.6 | 10 nm floating pass | 12.5 | Release layer/mask/ |
| | | | | | | | | transfer layer |

TABLE 3

| | | | | | | | | Target of |
|---|---|---|---|---|---|---|---|---|
| | | | First | Second | SP value | Glide evaluation | | three-dimensional |
| | | Microparticle | solvent | solvent | difference | result | SNR (dB) | pattern transfer |
| Comparative | 1 | Au | Toluene | Water | 14.5 | 10 nm floating NG | 6.5 | Mask/transfer |
| Example | | | | | | | | layer |
| | 2 | Au | Toluene | Ethanol | 5.6 | 10 nm floating NG | 5.9 | Mask/transfer |
| | | | | | | | | layer |
| | 3 | Au | Water | Toluene | 14.5 | 10 nm floating NG | 6.2 | Mask/transfer |
| | | | | | | | | layer |
| | 4 | Au | Ethanol | Toluene | 5.6 | 10 nm floating NG | 6 | Mask/transfer |
| | | | | | | | | layer |
| | 5 | Au | Toluene | — | — | 12 nm floating NG | 4.8 | Mask/transfer |
| | | | | | | | | layer |
| | 6 | Au | Water | — | — | 12 nm floating NG | 3.9 | Mask/transfer |
| | | | | | | | | layer |

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic recording medium manufacturing method comprising:
forming a magnetic recording layer on a substrate;
forming a mask layer on the magnetic recording layer;
coating the mask layer with a metal fine particle coating solution containing metal fine particles and a first solvent, thereby forming a metal fine particle coating layer having a multilayered structure of the metal fine particles;
dropping, on the coating layer, a second solvent having a second solubility parameter having a difference of 0 to 12.0 from a first solubility parameter of the first solvent, thereby forming a monolayered metal fine particle film by washing away excessive metal fine particles and changing the multilayered structure of the metal fine particles into a monolayer;
transferring a projections pattern made of the monolayered metal fine particle film to the mask layer;
transferring the projections pattern to the magnetic recording layer; and
removing the mask layer from the magnetic recording layer.

2. The method according to claim 1, wherein the metal fine particle is made of at least one material selected from the group consisting of carbon, aluminum, silicon, titanium, iron, cobalt, nickel, copper, zinc, zirconium, molybdenum, ruthenium, palladium, silver, tantalum, tungsten, platinum, gold, cerium, and alloys and compounds thereof.

3. The method according to claim 1, wherein the first solubility parameter and the second solubility parameter are 7 to 24.

4. The method according to claim 1, wherein coating methods of the metal fine particle coating layer and the second solvent are selected from spin coating, dip coating, spin casting, and an ink-jet method.

5. The method according to claim 1, further comprising forming a pattern transfer layer between the monolayered metal fine particle film and the mask layer.

6. The method according to claim 1, further comprising forming a release layer between the mask layer and the magnetic recording layer.

7. A stamper manufacturing method comprising:
coating a substrate with a metal fine particle coating solution containing metal fine particles and a first solvent, thereby forming a metal fine particle coating layer having a multilayered structure of the metal fine particles;
dropping, on the coating layer, a second solvent having a second solubility parameter having a difference of 0 to 12.0 from a first solubility parameter of the first solvent, thereby forming a monolayered metal fine particle film by washing away excessive metal fine particles and changing the multilayered structure of the metal fine particles into a monolayer;
forming, on a projections pattern made of the monolayered metal fine particle film, a conductive layer having the projections pattern;
forming an electroformed layer by using the conductive layer as an electrode; and
forming a stamper made of the electroformed layer on which the projections pattern is transferred by removing the conductive layer.

8. The method according to claim 7, further comprising:
forming a mask layer between the substrate and the metal fine particle coating layer;
transferring the projections pattern to the mask layer before the forming the conductive layer having the projections pattern; and
forming the conductive layer having the projections pattern on the projections pattern made of the monolayered metal fine particle film and the mask layer.

9. A magnetic recording medium manufacturing method comprising:
coating a substrate with a metal fine particle coating solution containing metal fine particles and a first solvent, thereby forming a metal fine particle coating layer having a multilayered structure of the metal fine particles;
dropping, on the coating layer, a second solvent having a second solubility parameter having a difference of 0 to 12.0 from a first solubility parameter of the first solvent, thereby forming a monolayered metal fine particle film by washing away excessive metal fine particles and changing the multilayered structure of the metal fine particles into a monolayer;
forming, on a projections pattern made of the monolayered metal fine particle film, a conductive layer having the projections pattern;
forming an electroformed layer by using the conductive layer as an electrode;
forming a stamper made of the electroformed layer on which the projections pattern is transferred by removing the conductive layer;
forming a magnetic recording layer on the substrate;
forming a mask layer on the magnetic recording layer;
forming an imprint resist layer on the mask layer;
transferring the projections pattern to the imprint resist layer by using the stamper;
transferring the projections pattern to the mask layer;
transferring the projections pattern to the magnetic recording layer; and
removing the mask layer from the magnetic recording layer.

10. The method according to claim 9, further comprising:
forming a mask layer between the substrate and the metal fine particle coating layer;
transferring the projections pattern to the mask layer before the forming the conductive layer having the projections pattern; and
forming, on the projections pattern made of the monolayered metal fine particle film and the mask layer, the conductive layer having the projections pattern.

11. A magnetic recording medium manufactured by a magnetic recording medium manufacturing method comprising:
forming a magnetic recording layer on a substrate;
forming a mask layer on the magnetic recording layer;
coating the mask layer with a metal fine particle coating solution containing metal fine particles and a first solvent, thereby forming a metal fine particle coating layer having a multilayered structure of the metal fine particles;
dropping, on the coating layer, a second solvent having a second solubility parameter having a difference of 0 to 12.0 from a first solubility parameter of the first solvent, thereby forming a monolayered metal fine particle film by washing away excessive metal fine particles and changing the multilayered structure of the metal fine particles into a monolayer;
transferring a projections pattern made of the monolayered metal fine particle film to the mask layer;
transferring the projections pattern to the magnetic recording layer; and
removing the mask layer from the magnetic recording layer.

12. A magnetic recording medium manufactured by a magnetic recording medium manufacturing method comprising:
coating a substrate with a metal fine particle coating solution containing metal fine particles and a first solvent, thereby forming a metal fine particle coating layer having a multilayered structure of the metal fine particles;
dropping, on the coating layer, a second solvent having a second solubility parameter having a difference of 0 to 12.0 from a first solubility parameter of the first solvent, thereby forming a monolayered metal fine particle film by washing away excessive metal fine particles and changing the multilayered structure of the metal fine particles into a monolayer;
forming, on a projections pattern made of the monolayered metal fine particle film, a conductive layer having the projections pattern;
forming an electroformed layer by using the conductive layer as an electrode;
forming a stamper made of the electroformed layer on which the projections pattern is transferred by removing the conductive layer;
forming a magnetic recording layer on the substrate;
forming a mask layer on the magnetic recording layer;
forming an imprint resist layer on the mask layer;
transferring the projections pattern to the imprint resist layer by using the stamper;
transferring the projections pattern to the mask layer;
transferring the projections pattern to the magnetic recording layer; and
removing the mask layer from the magnetic recording layer.

13. A magnetic recording/reproduction apparatus comprising a magnetic recording medium manufactured by a magnetic recording medium manufacturing method comprising:
forming a magnetic recording layer on a substrate;
forming a mask layer on the magnetic recording layer;
coating the mask layer with a metal fine particle coating solution containing metal fine particles and a first solvent, thereby forming a metal fine particle coating layer having a multilayered structure of the metal fine particles;
dropping, on the coating layer, a second solvent having a second solubility parameter having a difference of 0 to 12.0 from a first solubility parameter of the first solvent, thereby forming a monolayered metal fine particle film by washing away excessive metal fine particles and changing the multilayered structure of the metal fine particles into a monolayer;
transferring a projections pattern made of the monolayered metal fine particle film to the mask layer;
transferring the projections pattern to the magnetic recording layer; and
removing the mask layer from the magnetic recording layer.

14. A magnetic recording/reproduction apparatus comprising a magnetic recording medium manufactured by a magnetic recording medium manufacturing method comprising:
coating a substrate with a metal fine particle coating solution containing metal fine particles and a first solvent, thereby forming a metal fine particle coating layer having a multilayered structure of the metal fine particles;
dropping, on the coating layer, a second solvent having a second solubility parameter having a difference of 0 to 12.0 from a first solubility parameter of the first solvent, thereby forming a monolayered metal fine particle film by washing away excessive metal fine particles and changing the multilayered structure of the metal fine particles into a monolayer;
forming, on a projections pattern made of the monolayered metal fine particle film, a conductive layer having the projections pattern;
forming an electroformed layer by using the conductive layer as an electrode;
forming a stamper made of the electroformed layer on which the projections pattern is transferred by removing the conductive layer;
forming a magnetic recording layer on the substrate;
forming a mask layer on the magnetic recording layer;
forming an imprint resist layer on the mask layer;
transferring the projections pattern to the imprint resist layer by using the stamper;
transferring the projections pattern to the mask layer;
transferring the projections pattern to the magnetic recording layer; and
removing the mask layer from the magnetic recording layer.
